(19) United States
(12) Patent Application Publication
(10) Pub. No.: US 2022/0188588 A1
(43) Pub. Date: Jun. 16, 2022

(54) Smart Package for Inductive Heating

(71) Applicant: Inductive Intelligence LLC, Fennville, MI (US)

(72) Inventors: David W. Baarman, Fennville, MI (US); Gregory L. Clark, Ada, MI (US); Benjamin C. Moes, Wyoming, MI (US); Joseph Van Den Brink, Coopersville, MI (US); Toussaint Cruise, Grand Rapids, MI (US)

(73) Assignee: Inductive Intelligence LLC, Fennville, MI (US)

(21) Appl. No.: 17/122,007

(22) Filed: Dec. 15, 2020

(51) Int. Cl. G06K 19/07; G06K 19/077

(52) U.S. Cl. CPC G06K 19/0723; H05B 6/10; G06K 19/0717; G06K 19/07773

(57) ABSTRACT

A smart package and/or a smart tag may be used for inductive heating. The inductive heating may comprise heating a food product, a beverage product, and/or any other substance. The smart package and/or tag may comprise at least one of: an antenna (e.g., for radio frequency communications), a communication module (e.g., for communicating information relating to inductive heating), and/or an inductive receptor (e.g., for transferring heat to a substance). The inductive receptor may be configured to avoid/minimize contact and/or to avoid/minimize interference with the communication module and/or with the antenna, which may provide various advantages as described herein.

### BACKGROUND

Materials may be heated using electromagnetic induction. Applications for electromagnetic induction heating include cooking and warming food/beverages. Radio frequency (RF) properties associated with induction heating may interfere with communication systems in close proximity to a heated element. Exposure of electronic components to high temperatures that may occur during induction heating may result in damage and/or failure of the electronic components. Challenges arise in providing a reliable system for cooking and/or warming food/beverages using induction heating.

### SUMMARY

A smart package and/or a smart tag may be used for inductive heating. The inductive heating may comprise heating a food product, a beverage product, and/or any other substance that may be associated with the smart package/tag. The smart package/tag may be coupled to (and/or integrated within) a product packaging material containing the substance to be heated (e.g., food, liquid, wax, etc.). The smart package/tag may comprise an antenna for radio frequency communications. The smart package/tag may send/receive one or more messages to/from a base station (e.g., via the antenna). The one or more messages may comprise information such as: temperature, package/tag identification, product identification, cooking profile, operational state, failure indication, and/or any other information relating to the inductive heating and/or the smart package/tag. The smart package/tag may comprise a communication module. The communication module may comprise at least one of: a temperature sensor, a controller, a memory, a voltage reference, a balancing module, a harvesting module, and/or an indicator, each of which may perform one or more operations to provide advantages for inductive heating described herein. For example, the communication module may measure a temperature associated with a substance that may be heated. The communication module may comprise a plurality of temperature sensors to provide redundancies for improved operation, such as failure detection, prevention of overheating, increased accuracy in heating, and/or other advantages described herein. The base station may comprise an inductive heating element for heating a substance associated with the smart package/tag. The smart package/tag may comprise an inductive receptor for transferring heat (e.g., from the inductive heating element at the base station) to the substance. The inductive receptor may be configured to avoid/minimize contact and/or to avoid/minimize interference with the communication module and/or with the antenna. For example, the inductive receptor may comprise a void. The communication module and/or the antenna may be located within the void such that the communication module and/or the antenna do not contact the inductive receptor. The arrangement of the communication module relative to the inductive receptor (and/or the shape/size of the inductive receptor) may provide improvements for inductive heating operations, such as reduced likelihood of damage to the communication module from heat. Additionally or alternatively, the arrangement of the antenna relative to the inductive receptor (and/or the shape/size of the inductive receptor) may provide improvements for inductive heating operations and associated communications, such as reduced radio frequency interference from heat. These and other advantages are described further herein.

The smart package/tag may be configured in various manners. The smart package/tag may be configured as a product label (e.g., a sticker, a portion of product packaging material, etc.). The smart package/tag may be assembled in a roll, a strip, and/or a sheet of a plurality of smart packages/tags, for example, for application to (and/or within) product packaging material (e.g., a food wrapper, a beverage container, a scented wax package, etc.). The smart package/tag may comprise (and/or may be applied to) one or more layers of material, such as adhesives, insulation, heat concentrators, and/or any other material. The smart package/tag may be located in a position to be visible to a user (e.g., external to product packaging) or may located in a position that may not be readily visible to a user (e.g., may be internal to product packaging).

The smart package/tag may be configured in the form of a smart accessory. For example, the smart accessory may comprise an object that may be inserted (e.g., by a user, by a manufacturer, and/or by a food/beverage/product processor) into a container for heating contents of the container. The smart accessory may comprise any material (e.g., such as silicone, plastic, glass, composite, and/or the like) that may allow for the smart accessory to be cleaned and/or reused. Additionally or alternatively, the smart accessory may comprise any material (e.g., paper, cardboard, plastic, and/or the like) that may be intended to be disposable and/or recyclable. The smart accessory may be configured in any shape and/or size, for example, based on a shape/size of a container (e.g., a cup, a mug, a bowl, a pan, a dish, a candle holder, etc.), a type of heating (e.g., cooking food, warming a beverage, heating wax, etc.), and/or a type of substance to be heated (e.g., food, liquid, wax, etc.).

The smart package/tag may be configured in the form of a smart apparatus. For example, the smart apparatus may comprise a base and/or a heat concentrator that may be adapted to receive a container (e.g., a can, a cup, a mug, a bowl, etc.) and/or substance (e.g., food, liquid, wax, etc.). The base of the smart apparatus may comprise a communication module for communicating with a base station for the purposes of inductive heating operations. A heat concentrator (e.g., an inductive receptor) may be internal or external to the base (e.g., part of the base or separate from the base). The smart apparatus may comprise any material (e.g., such as silicone, plastic, glass, composite, and/or the like) that may allow for the smart apparatus to be cleaned and/or reused. Additionally or alternatively, the smart apparatus may comprise any material (e.g., paper, cardboard, plastic, and/or the like) that may be intended to be disposable and/or recyclable. The smart apparatus may be configured in any shape and/or size, for example, based on a shape/size of a container (e.g., a cup, a mug, a bowl, a pan, a dish, a candle holder, etc.), a type of heating (e.g., cooking food, warming a beverage, heating wax, etc.), and/or a type of substance to be heated (e.g., food, liquid, wax, etc.).

The smart package/tag may be configured in the form of an apparatus and/or system comprising thermal harvesting feedback. For example, a vessel may comprise a thermal harvesting feedback device and/or one or more temperature sensors. The thermal harvesting feedback device may comprise one or more components of the smart package/tag. The vessel may be configured as any device that may be used for heating a substance, such as a pot, a pan, a bowl, a dish, a stovetop, and/or the like. The vessel may use a Peltier effect for powering a communication module, for example, based on a temperature differential. For example, a heating surface of the vessel may be measured at a first temperature (e.g., a high temperature) and another portion of the vessel (e.g., a handle, knob, etc.) may be measured at a second temperature (e.g., a low temperature) that may be different from (e.g., substantially different from) the first temperature. The difference between the first temperature and the second temperature may provide energy to power one or more operations of a communication module within or coupled to the vessel. The vessel may provide various advantages for heating, such as improved safety and/or accuracy (e.g., avoiding overheating and/or fires) via monitoring (e.g., temperature, gas, and/or any other condition that may be sensed) and/or via an automated operation (e.g., via a base station and/or any other device) to adjust heating operations based on one or more conditions.

These and other features and advantages are described in greater detail below.

### BRIEF DESCRIPTION OF THE DRAWINGS

The following figures are provided to show example features. These example features are not intended to be limiting. Like numerals reference similar elements.

FIG. 1 shows an example of a smart package.

FIG. 2 shows an example of a base station.

FIG. 3A shows an example of an inductive receptor.

FIG. 3B shows an example of an inductive receptor.

FIG. 3C shows an example of an inductive receptor.

FIG. 3D shows an example of an inductive receptor.

FIG. 4 shows an example of a communication tag.

FIG. 5A shows an example of an assembly comprising an inductive receptor and a communication module.

FIG. 5B shows an example of a smart package assembly and a base station.

FIG. 5C shows an example of an assembly for a smart package/tag.

FIG. 5D shows an example of a method for providing a smart package/tag.

FIG. 6A shows an example of a smart accessory.

FIG. 6B shows an example of a smart accessory within a container.

FIG. 7A shows an example of a concentrator.

FIG. 7B shows an example of a smart apparatus in combination with a concentrator and a container.

FIG. 8 shows an example of a method for detection of a smart package, a smart accessory, and/or a smart apparatus.

FIG. 9 shows an example of a method for detection and/or heating.

FIG. 10 shows an example of a method for heating.

FIG. 11 shows an example of a method for heating.

FIG. 12 shows an example of a method for heating.

FIG. 13 shows an example of a method for heating.

FIG. 14 shows an example of an apparatus and/or a system comprising thermal harvesting feedback.

FIG. 15 shows an example of an apparatus and/or a system comprising thermal harvesting feedback.

### DETAILED DESCRIPTION

The following detailed description and the corresponding drawings provide various examples relating to inductive heating and associated operations. The examples described and/or shown in the drawings are non-exclusive, and features described and shown may be practiced in other examples. Examples are provided for a smart package/tag and associated systems, apparatuses, and methods.

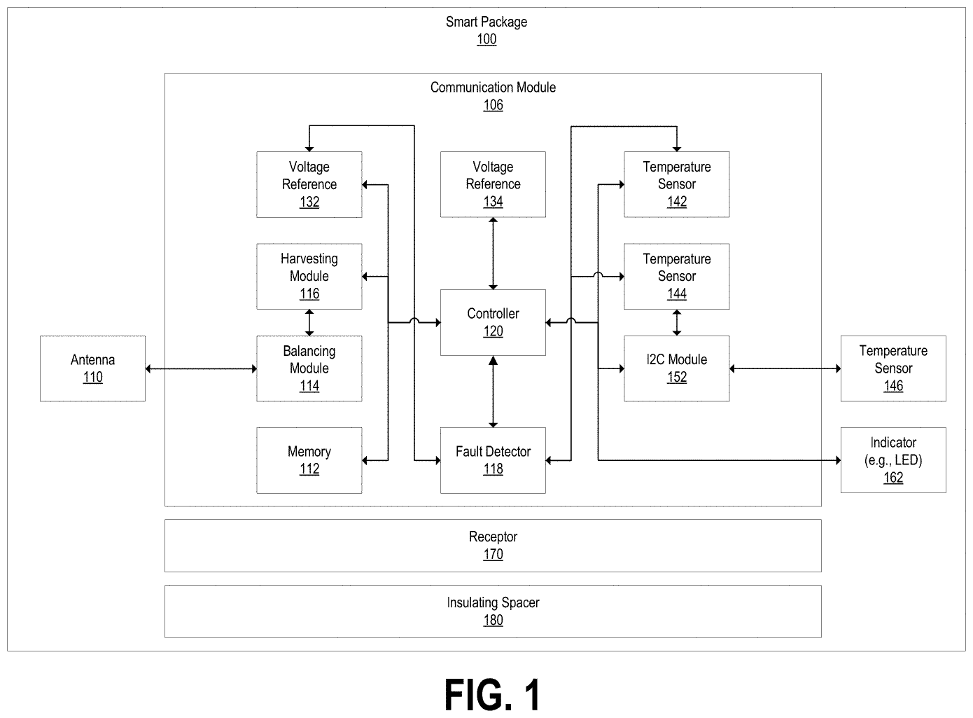

FIG. 1 shows an example of a smart package. A smart package 100 may comprise one or more of: an antenna 110, a communication module 106, a receptor 170, a spacer 180, a temperature sensor 146, and/or an indicator 162. The communication module 106 may perform various operations. The operations may comprise, for example, wireless communications (e.g., via an antenna 110 and/or any other wireless interface) and/or wired communications (e.g., via circuitry, connections between components, and/or any other wired connection). The communication module 106 may enable heating of the smart package 100 (e.g., via an induction heating device). The smart package 100 may comprise a receptor 170, such as an inductive receptor, that may be heated via induction as described herein. The receptor 170 may provide heat for heating the smart package 100 and/or contents within the smart package 100 (e.g., food product, a liquid, and/or other substance within the smart package 100). The smart package 100 may comprise a spacer 180, such as an insulating space, that may separate the communication module 106 and the receptor 170. The spacer 180 may shunt electromagnetic energy and/or thermal energy between the communication module 106 and the receptor 170. The spacer 180 may comprise any size and/or shape, and/or may vary in size/shape based on a desired operation and/or based on a type of substance to be heated.

The communication module 106 may comprise an antenna 110. Additionally or alternatively, the antenna 110 may be external to the communication module (such as shown in FIG. 1), the communication module 106 may be mounted on top (or below) the antenna 110, and/or the antenna 110 may be in any location relative to the communication module 110. The antenna 110 may comprise a transponder, such as a near-field communication (NFC) tag, an electromagnetic energy (EME) energized radio frequency identification (RFID) tag, and/or a light-energized micro-transponder (LEM). The antenna 110 may be any shape or size. For example, if the antenna 110 comprises an LEM, it may be a relatively small size (e.g., approximately 500×500 microns and/or 100 microns thick, or any other size), whereas if the antenna 110 comprises an NFC tag and/or an EME tag, it may be a relatively larger size (e.g., greater than 500×500 microns and 100 microns thick, or any other size). The antenna 110 comprise one or more coils. The smart package 100 may send and/or receive (e.g., via the communication module 106) one or more signals via the antenna 110. For example, the communication module 106 may send information to a reader (e.g., an NFC reader), or any other communication device (e.g., transmitter and/or receiver), via the antenna 110. The antenna 110 may be coupled to and/or communicate with a balancing module 114. For example, the smart package may be associated with one or more identifiers (e.g., a unique identifier). The identifier(s) may identify the smart package 100 by one or more of: type, characteristic, product, content(s), unique identification, and/or any other information. The identifier(s) may be stored in a memory 112. The memory 112 may comprise any type of memory, such as read/write non-volatile memory, random access memory (RAM), read-only memory (ROM), removable memory, non-removable memory, and/or any other memory. The smart package 100 may send one or more identifiers (e.g., that may be stored in the memory 112), via the antenna 110, to any device (e.g., base station, appliance, and/or any other device). The smart package 100 may send the one or more identifier(s), for example, based on an energization of the antenna 110, such as by an NFC tag and/or an EME tag. The smart package 100 may send the one or more identifier(s) via the antenna 110, for example, based on an energization of photocells (e.g., on the antenna 110) by received light (e.g., pulsed laser light), such as by an LEM.

The antenna 110 (e.g., an RFID tag, an NFC tag, and/or any device with an inductive antenna that may generate current) may enable the communication module 106 to harvest energy (e.g., via a harvesting module 116) from an external source (e.g., from electromagnetic pulse energy). The communication module 106 may use the harvested energy to power the antenna 110 and/or one or more other components of the communication module 106. For example, excess power available from the antenna 110 may be used to power one or more of a temperature sensor (e.g., temperature sensor 142, temperature sensor 144, and/or temperature sensor 146) and/or any other sensor (e.g., pressure sensor, tamper seal sensor, moisture sensor, and/or any other sensor that may not be shown in FIG. 1). The antenna 110 may be coupled to and/or in communication with a controller 120 (e.g., via the balancing module 114 and/or via the harvesting module 116). The controller 120 may comprise one or more of a microprocessor and/or any other electronic controller. The controller 120 may communicate with and/or control components of the communication module 106. The controller may control delivery of harvested energy by the communication module 106. Harvested energy may be stored, such as in a storage device (e.g., battery, capacitor, etc.). Energy (e.g., harvested energy and/or other stored energy) may be stored within the communication module 106 and/or external from the communication module 106. One or more temperature sensors (e.g., temperature sensor 142, temperature sensor 144, and/or temperature sensor 146) may be used to control heating of the smart package 100. One or more temperature sensors may be internal to the communication module 106, such as shown in FIG. 1 with respect to the temperature sensor 142 and the temperature sensor 144. One or more temperature sensors may be external to the communication module 106, such as shown in FIG. 1 with respect to the temperature sensor 146. For example, the temperature sensor 146 may be located at any location of the smart package 100, such as any internal location of the smart package 100, any external location of the smart package 100 (e.g., outer packaging), and/or in any layer(s) of the smart package 100. The heating may be controlled based on (e.g., according to) one or more thresholds (e.g., preset threshold, adjustable threshold, and/or any other threshold). The one or more thresholds may be associated with (e.g., stored within) one or more heating profiles. The smart package may be associated with one or more heating profiles, for example, to provide desired heating (e.g., based on one or more of efficiency, safety, time, cooking temperature, consumption temperature, and/or any other factor/condition) of contents within the smart package. In addition to or in the alternative of one or more temperature sensors, one or more pressure sensors may be used to control one or more heating operations, such as a heating operation involving steaming and/or an internal package pressure. One or more components of the communication module 106 may communicate using one or more protocols and/or interfaces. For example, one or more components of the communication module 106 may communicate using inter-integrated circuit (I2C) protocol (e.g., via an I2C module 152) and/or any other communication protocol.

The communication module 106 may comprise a balancing module 114. The balancing module 114 may comprise one or more inductors, one or more capacitors, and/or any other component (e.g., electronic circuitry). The balancing module 114 may be coupled to and/or in communication with the antenna 110 and/or a harvesting module 116. For example, the antenna 110 and the balancing module 114 may comprise a balancing L-C circuit (e.g., an inductance/capacitance balancing circuit), such that the balancing module 114 may balance (e.g., based on capacitance) an input from the antenna 110 (e.g., based on inductance). The balancing module 114 may adjust (e.g., tune) received communications and/or communications to be sent (e.g., radio frequency (RF) communications) to/from one or more frequencies (e.g., a configured frequency). For example, the balancing module 114 may adjust (e.g., tune) a received RF signal (e.g., 2.4 GHz, 433 MHz, 125 KHz, and/or any other frequency) to reduce and/or increase a frequency of the received signal, and/or the balancing module 114 may filter one or frequencies from the received RF signal. The balancing module 114 may be tuned for a particular smart package 100, for example, based on the size, shape, material, and/or contents of the smart package 100, based on the location of the communication module 106 relative to a receptor (e.g., the receptor 170), and/or based on the shape and/or size of a receptor. The balancing module 114 may be tuned via the controller 120 (e.g., based on one or more programs that may be stored, such as in the memory 112). The antenna 110 may receive RF communications comprising a first frequency (e.g., 13.53 MHz or any other frequency). The received signal may be communicated to the balancing module 114, and the balancing module 114 may adjust (e.g., tune) the received signal from the first frequency (e.g., 13.53 MHz or any other frequency) to a second frequency (e.g., up to 13.56 MHz, down to 13.50 MHz, and/or up/down to any other frequency). Any frequency or frequencies may be used as a configured frequency, a received frequency, and/or a transmission frequency.

The communication module 106 may comprise a harvesting module 116. The harvesting module 116 may be coupled to and/or in communication with the balancing module 114 and/or the controller 120. The harvesting module 116 may comprise an integrated circuit and/or any quantity of electrical components. The harvesting module 116 may receive an RF signal. The harvesting module 116 may receive an RF signal, for example, via the antenna 110. The RF signal may be generated by an induction field (e.g., generated by an induction heating device). The harvesting module 116 may convert the received RF signal to generate a voltage (e.g., 5V or any other voltage) and/or to provide an indication of a voltage (e.g., a digital representation of an analog voltage). The harvesting module 116 may rectify the received RF signal, for example, to generate a voltage and/or to provide an indication of a voltage. The harvesting module 116 may supply a voltage (e.g., the generated voltage) to one or more components (e.g., controller 120, memory 112, and/or any other component) of the communication module 106. For example, the harvesting module 116 may generate a voltage to provide power to the controller 120. The controller 120 may control and/or provide power to one or more components of the communication module 106 (e.g., fault detector 118, temperature sensor 142, temperature sensor 144, temperature sensor 146, and/or any other component). The harvesting module 116 may provide at least some, or all, power that may be required for operation of one of more components of the communication module. The harvesting module 116 may use Manchester modulation (e.g., after powering up the controller 120) by shorting a field and encoding data that may be sent/received (e.g., bi-directional communications). For example, a field generated by a transmitter may send a signal to the antenna 110 (e.g., to confirm whether a device, such as the base station 200) is configured to receive a transmission (e.g., whether the device is awake and/or in an operational state). Temperature data may be sent back to the device (e.g., the base station 200) using the same (or a similar) coding methodology as a received message, which may provide confirmation of communications for the communication module 106 and the device (e.g., the base station 200).

The communication module 106 may comprise a memory 112. The memory 112 may comprise a non-volatile storage medium (e.g., flash memory, magnetic disk storage, optical storage). The controller 120 may read and/or write information (e.g., one or more signals, bits, and/or commands) from/to the memory module 112. For example, the controller 120 may write an indication of a temperature (or other measurement) that may be measured at a sensor (e.g., temperature sensor 142, temperature sensor 144, temperature sensor 146, and/or any other sensor) to the memory 212. The memory 112 may store one or more computer-readable instructions to perform one or more operations of the communication module 106 as described herein. The memory 112 may store an identifier (e.g., a unique identifier associated with the smart package 100). The memory 112 may comprise a stored identifier, such as an electronic serial number (ESN) and/or other data that may be stored (e.g., previously stored during a package manufacturing, test, calibration, and/or initialization operation).

The communication module 106 may comprise a controller 120. The controller 120 may comprise one or more processors (e.g., integrated circuit(s), application-specific integrated circuits (ASICs), and/or the like). The controller 120 may receive, transfer, send, and/or transmit information (e.g., one or more of a command, signal, data, indicator, and/or any other information) within the communication module 106. The controller 120 may receive, transfer, send, and/or transmit information external from the smart package 100 (e.g., via the antenna 110). The controller 202 may be coupled to and/or in communication with the harvesting module 116, one or more voltage reference modules (e.g., voltage reference 132, voltage reference 134, and/or any other voltage reference), a fault detector 118, one or more sensors (e.g., temperature sensor 142, temperature sensor 144, temperature sensor 146, and/or any other sensor), an I2C module 152, one or more light emitting diodes (LED) 262, and/or any other component. The controller 120 may be powered (e.g., in-part or entirely) by the harvesting circuit 116 and/or by a power system coupled to and/or in communication with the communication module 106. The controller 120 may comprise one or more computer-readable instructions (e.g., non-transitory computer-readable medium) that may enable one or more features of any communication module (e.g., the communication module 106) described herein.

The communication module 106 may comprise one or more voltage references (e.g., voltage reference 132, voltage reference 134, and/or any other voltage reference). The voltage reference 132 may be coupled to and/or in communication with the controller 120 and/or a fault detector 118. The voltage reference 134 may be coupled to and/or in communication with the controller 120. The one or more voltage references may comprise one or more components (e.g., resistor(s), capacitor(s), voltage source(s), current sources, voltage regulators, and/or any other component) that may be used, alone or in combination, to maintain a static voltage (e.g., a fixed and/or an approximately fixed voltage level within a threshold range, such as +/−1%, 2%, 5%, or any other threshold range relative to a target voltage value) and/or a variable voltage (e.g., within a threshold range, such as +/−1%, 2%, 5%, 10%, 50%, 100%, or any other threshold range relative to a target voltage value) for a time duration (e.g., during operation of the communication module 106). The voltage(s) associated with a voltage reference may be modified, for example, by the controller 120, by one or more sensors (e.g., temperature sensor 142, temperature sensor 144, temperature sensor 146, and/or any other sensor), and/or by a command such as via the antenna 110 or any other input to the communication module 106. As an example, the voltage reference 132 may maintain a first voltage output (e.g., 3.3 volts, or any other static or variable voltage output) that may be coupled to (e.g., directly and/or indirectly, such as via the controller 120) and/or in communication with a sensor (e.g., temperature sensor 142) to enable one or more sensing capabilities (e.g., temperature sensing). Additionally or alternatively, the voltage reference 134 may maintain a second voltage output (e.g., a variable voltage from 0.5V-3.3V, or any other variable or status voltage output). The voltage of one or more voltage references (e.g., the voltage reference 134) may vary, for example, based on (e.g., in correlation with) a temperature recorded at a temperature sensor (e.g., temperature sensor 144) and/or based on any value that may be sensed by one or more sensors (e.g., temperature sensors 142, temperature sensor 144, temperature sensor 146, and/or any other sensor).

The controller 120 may perform one or more operations to determine a temperature of the smart package 100 and/or of contents therein. For example, a first voltage reference (e.g., voltage reference 132) may be offset by a value (e.g., 0.5V or any other value). A first temperature sensor (e.g., temperature sensor 142) may be measured (e.g., by the controller 120). The controller 120 may determine whether the first temperature sensor indicates a value consistent with the offset applied to the first voltage reference. The controller 120 may determine (e.g., validate) that an A/D conversion is correct (e.g., working properly), for example, based on a determination of whether the first temperature sensor indicates a value consistent with the offset applied to the first voltage reference. A second temperature sensor (e.g., temperature sensor 144) may be measured (e.g., by the controller 120). The second temperature sensor may be in close proximity with the first temperature, for example, such that measured temperatures for each of the first and second temperature sensors are expected to be approximately the same under proper operation (e.g., within a tolerance of temperature sensor performance/accuracy). The controller 120 may determine whether the second temperature sensor indicates a value consistent with a second voltage reference (e.g., voltage reference 134). The controller 120 may remove the offset from the first voltage reference (e.g., voltage reference 132), for example, after validating the A/D conversion. The controller 120 may compare a measurement from the first temperature sensor (e.g., temperature sensor 142) with a measurement from the second temperature sensor (e.g., temperature sensor 144). The controller 120 may determine whether the measurements from the first and second temperature sensors are accurate, for example, based on determining whether the measurement from the first temperature sensor (e.g., temperature sensor 142) is within a threshold of the measurement from the second temperature sensor (e.g., temperature sensor 144). The threshold may comprise, for example, +/−0.5 or 1 degree Fahrenheit, +/−0.5 or 1%, or any other quantity/range and/or unit of measurement. For example, the comparison may be a determination of whether the measurements are approximately the same value (e.g., within a tolerance of temperature sensor performance/accuracy). Based on one or more of the above operations, the controller 120 may determine whether a temperature measurement is accurate and/or whether the temperature measurement and/or an indication (e.g., a fault indication, an error indication, a safety warning, etc.) should be communicated (e.g., to the base station 200). For example, if the controller 120 determines that the temperature measurement may not be accurate (e.g., based on a difference, between the measurement from the first temperature sensor and the measurement from the second temperature, being above a threshold), the controller 120 may send one or more messages (e.g., via the antenna 110 to a base station such as the base station 200) indicating a failure and/or any other information relating to the measurements.

The communication module 106 may comprise one or more sensors (e.g., temperature sensor 142, temperature sensor 144, temperature sensor 146, and/or any other sensor). The one or more sensors may be coupled to (e.g., secured removably or permanently to) an exterior of, and/or located within (e.g., secured removably or permanently inside of), the smart package 100. The temperature sensor 142 may be coupled to a fault detector 118 and/or the controller 120. One or more sensors (e.g., temperature sensor 144) may be coupled to and/or in communication with the fault detector 118, the I2C module 152, the controller 120, and/or any other component of the communication module 106. One or more sensors (e.g., temperature sensor 146) may be coupled to and/or in communication with the I2C module 152. One or more sensors (e.g., temperature sensor 142, temperature sensor 144, temperature sensor 146, and/or any other sensor) may measure a temperature at an approximate location of the temperature sensor (e.g., the exterior of the smart package 100, at an inductive receptor 170, within or adjacent to the communication module 106, and/or at any other location). For example, the temperature sensor 142 may be coupled to, and/or located adjacent to, the exterior of the smart package 100 (e.g., to measure ambient temperature). Additionally or alternatively, the temperature sensor 144 may be coupled to, and/or located adjacent to, the inductive receptor 170 (e.g., to measure the temperature at the inductive receptor 170). Additionally or alternatively, the temperature sensor 146 may be coupled to, and/or located within or adjacent to, an external or internal area (e.g., surface area) of the communication module 106 (e.g., to measure the temperature at an external and/or internal area of the communication module 106). Additionally or alternatively, any quantity of sensors (e.g., temperature sensors and/or any other sensor(s)) may be coupled to, and/or located within or adjacent to, any component of the smart package 100 (e.g., to measure a temperature and/or any other condition at or near such component(s) of the smart package 100). The controller 120 may receive (e.g., read, query, and/or command an operation for providing) the measured temperature (and/or any other condition) from the one or more sensors (e.g., temperature sensor 142, temperature sensor 144, temperature sensor 146, and/or any other sensor).

Examples described herein may provide advantages for improved safety and/or security. For example, the communication module 106 may comprise more than one temperature sensor (e.g., temperature sensor 142, 144, and/or 146) and a fault detector 118. A temperature of a package (e.g., a smart package 100 that may lack more than one temperature sensor) may exceed a threshold of a safe temperature and/or may become inoperable. For example, if the package is heated beyond a threshold temperature, one or more components may become faulty which could lead to overheating (e.g., burning food product within the package) and/or safety issues (e.g., causing a fire due to excessive heating and/or excessive temperature). A package comprising only one temperature sensor may be subjected to one or more of the above issues, for example, if the temperature sensor fails and/or indicates an incorrect temperature. For example, a base station (e.g., the base station 200) and/or a smart package may not be able to determine whether a single temperature sensor is providing an accurate measurement (e.g., whether a single temperature sensor is damaged and/or not operating correctly), for example, if that measurement cannot be compared with a measurement by a second temperature sensor (or any other quantity of temperature sensors). As described herein, the smart package may comprise more than one temperature sensor (e.g., temperature sensor 142, 144, and/or 146) which may provide redundancy for increased accuracy and/or increased reliability of a temperature measurement (e.g., and in turn, increased accuracy/reliability of sending an indication of an actual temperature).

The communication module 106 may comprise a fault detector 118. The fault detector 118 may be used with more than one temperature sensor (e.g., temperature sensor 142, 144, and/or 146) to provide advantages described herein, such as improved heating precision and/or heating accuracy, and/or increased safety. The fault detector 118 may comprise one or more of: a watch dog module, a comparator, an error detection, a warning device, and/or an alarm. The fault detector 118 may be coupled to and/or in communication with the controller 120, one or more references such as voltage reference(s) (e.g., voltage reference 132, voltage reference 134, and/or any other voltage reference) and/or any other reference (e.g., current reference, temperature reference, etc.), and/or one or more sensors (e.g., temperature sensor 142, temperature sensor 144, and/or any other sensor). A temperature sensor (e.g., temperature sensor 142 or temperature sensor 144) may be associated with a particular voltage reference (e.g., voltage reference 132 or voltage reference 134), and/or vice versa. For example, the temperature sensor 142 may be associated with the voltage reference 132, and the temperature sensor 144 may be associated with the voltage reference 134. The controller 120 may be electrically coupled to the voltage reference 134 and the fault detector 118, and the fault detector 118 may be electrically coupled to the voltage reference 132 and the controller 120. Such a configuration may enable operations such as comparing voltages (e.g., comparing voltage reference 132 and voltage reference 134), confirming operation of the controller 120, confirming correct voltage levels associated with multiple temperature measurements (e.g., from temperature sensor 142 and from temperature sensor 144), and determining an accurate temperature of the smart package 100. By providing redundancies as described herein, such as multiple voltage references and/or multiple temperature sensors, the smart package 100 may improve operation by increasing accuracy and/or reliability of measurements, and/or by increasing the safety of heating operations such as those described herein.

The fault detector 118 may be used to monitor and/or validate/invalidate one or more operations of the communication module 106. The fault detector 118 may monitor and/or validate/invalidate an operation of the controller 120, one or more voltage references (e.g., voltage reference 132, voltage reference 134, and/or any other voltage reference), and/or one or more sensors (e.g., temperature sensor 142, temperature sensor 144, temperature sensor 146, and/or any other sensor). For example, the fault detector 118 may determine that a change in a condition (e.g., a temperature) at (e.g., as measured by) a first sensor (e.g., a temperature sensor such as temperature sensor 142) did not result in a corresponding (e.g., proportional, expected, etc.) change in voltage at (e.g., indicated by) a first voltage reference (e.g., voltage reference 132). The controller 120 may provide information to the fault detector 118 regarding one or more measurements (e.g., from temperature sensor 142, temperature sensor 144, temperature sensor 146, and/or any other sensor), one or more references (e.g., voltage reference 132, voltage reference 134, and/or any other reference), and one or more rules (e.g., relationship(s) between measurement(s) and reference(s) for determining a fault condition). The one or more rules may be stored in the memory 112 (e.g., and communicated by the controller 112) and/or may be stored in the fault detector 118. The controller 120 may send the one or more rules, and/or communicate one or more indications of the one or more rules, to the fault detector 118. The fault detector 118 may apply the one or more rules. For example, the fault detector 118 may apply the one or more rules by comparing the one or more measurements with the one or more references. If a comparison of a measurement with a reference is inconsistent with (e.g., indicates a failure of) one or more rules, the fault detector 118 may indicate a failure event. If a comparison of a measurement with a reference is consistent with (e.g., indicates a satisfactory condition based on) one or more rules, the fault detector 118 may indicate a success of the one or more rules and/or the fault detector 118 may not indicate a failure (e.g., the fault detector 118 may not provide any indication in response to a satisfactory condition based on one or more rules). If the fault detector 118 detects one or more failure events, the fault detector 118 may communicate an indication of the failure event to the controller 112 and/or to any other component (e.g., an audible alarm, a visual alarm, and/or via an electronic communication associated with the failure event(s)).

The fault detector 118 may reset and/or restart the communication module 106 and/or the controller 120. The fault detector 118 may reset and/or restart the communication module 106 and/or the controller 120, for example, based on monitoring and/or validating/invalidating one or more operations (e.g., based on detecting a failure event). The fault detector 118 may reset and/or restart the communication module 106 and/or the controller 120, for example, if a validation sequence fails for: the controller 120, one or more voltage references (e.g., voltage reference 132, voltage reference 134, and/or any other voltage reference), and/or one or more sensors (e.g., temperature sensor 142, temperature sensor 144, temperature sensor 146, and/or any other sensor). The fault detector 118 may reset the controller 120, for example, based on a determination that a change in a condition such as a temperature at (e.g., measured by) a sensor (e.g., temperature sensor 142, temperature sensor 144, temperature sensor 146, and/or any other sensor) did not result in a corresponding (e.g., proportional, expected, etc.) change in voltage at a reference such as a voltage reference (e.g., voltage reference 132, voltage reference 134, and/or any other reference).

The fault detector 118 may provide monitoring for the communication module 106 to validate/invalidate analog to digital (A/D) conversions (e.g., which may be performed by the controller 112, such as by converting an analog measurement to a digital value for comparing with a reference). The fault detector 118 may determine, for the communication module 106, one or more errors associated with timing, overvoltage, undervoltage, and/or any other condition relevant to one or more sensors and/or one or more references. The controller 120 may determine whether a failure may have occurred, for example, based on the fault detector 118 engaging and/or the fault detector sending a message to the controller 120 indicating an activation (e.g., an activation of a fault detection). Additionally or alternatively, a base station (e.g., the base station 200) may determine whether a failure may have occurred, for example, based on the fault detector 118 engaging and/or the fault detector sending a message to the base station indicating an activation (e.g., an activation of a fault detection). The message may comprise an indication of one or more of: a fault detection, an undervoltage, and overvoltage, and/or any other condition relevant to one or more sensors and/or one or more voltage references.

The communication module 106 may comprise a module for one or more types of communications, such as an inter-integrated circuit (I2C) module 152. The I2C module 152 may be coupled to and/or in communication with the controller 120, one or more sensors (e.g., the temperature sensor 146), and/or one or more indicators (e.g., indicator 162). The I2C module 152 may enable communications (e.g., serial communications) between the controller 120 and more one or more low speed integrated circuits and/or other components (e.g., temperature sensor 146) that may be coupled to and/or in communication with one or more other components of the communication module 106. The temperature sensor 146 may be located at a first location of the smart product 100 (e.g., external or internal to the communication module 106) that may be different from a second location at which other temperature sensors (e.g., the temperature sensor 142 and/or the temperature sensor 144) may be located. For example, the temperature sensor 146 may be located at or near a bottom and/or middle portion of the smart package 100 (e.g., relatively close to inductive coil(s) that may heat the smart package 100 and/or that may heat contents therein), and/or the temperature sensor(s) 142 and/or 144 may be located at or near a top and/or edge portion of the smart package 100 (e.g., relatively farther from inductive coil(s)).

The communication module 106 may comprise one or more indicators, such as indicator 162 (e.g., one or more LEDs). The indicator 162 may be activated (e.g., illuminated) by the controller 120. The indicator 162 may be activated by the controller 120, for example, based on one or more measurements at (e.g., measured by) one or more sensors (e.g., temperature sensor 142, temperature sensor 144, temperature sensor 146, and/or any other sensor). The indicator 162 may be activated, for example, if a sensor (e.g., temperature sensor 142) determines and/or indicates a measurement such as a temperature (e.g., indicating heating of the smart package 100 has concluded and/or is active). The indicator 162 may be illuminated to indicate one or more instructions (e.g., an indication to remove the smart package 100, rotate the smart package 100, and/or relocate the smart package 100) to a user and/or to another device (e.g., a mobile phone, an appliance, and/or any other device). For example, the indicator 162 may be illuminated (e.g., in a sequence) to indicate to a user that the user may rotate the position of the smart package 100. The indicator 162 may use one or more colors (e.g., red, blue, green, white, or any other color), intensities (e.g., magnitude, brightness, etc.), frequencies (e.g., periodic pulses of light, or durations of sustained illumination), patterns (e.g., different durations of illumination and/or patterns of different durations of illumination), characters (e.g., text, numerals, symbols, and/or images) and/or any other characteristic to indicate one or more messages. The one or more messages may be associated with any operation of the communication module 106 and/or condition of the smart package 100, such as heating of the smart package 100 in progress (e.g., red solid or pulsing light), heating of the smart package has concluded (e.g., green light), failure event such as overheating of the smart package (e.g., flashing red light), inactivity of the communication module 106 (e.g., blue or white). The one or more messages may be associated with an indication for a potential customer (e.g., indicating a sale price, a new item, and/or an availability, such as at a pre-purchase location in a store), an indication for a store employee/owner (e.g., indicating low stock, indicating past and/or upcoming expiration, etc.), and/or an indication for a vendor (e.g., indicating low stock, indicating location of related and/or complementary products, indicating competitor products, indicating products associated with the vendor, etc.). The indicator 162 may comprise one or more LEDs and/or may comprise one or more illuminating elements that may be integrated within the smart package 100 (e.g., LCD, filter, reflector, film, etc.). For example, the indicator 162 may illuminate the smart package 100. The indicator 162 may illuminate the smart package 100 to indicate an operation (e.g., heating in progress, heating complete, product identified, product present, etc.). The indicator 162 may illuminate the smart package to indication information that may not be related to an operation. For example, the indicator 162 may illuminate the smart package 100 at a store location, such as to bring attention to the smart package 100 and/or to indicate information about the smart package (e.g., sale price, inventory level, new product offering, complement to other product(s), and/or any other messaging that may be useful to a potential customer, a store owner/employee, a vendor, etc.). The indicator 162 may be controlled by any device that may communicate with the communication module 106 (e.g., a base station, a smart phone, a price scanner, an inventory checker, and/or any other device).

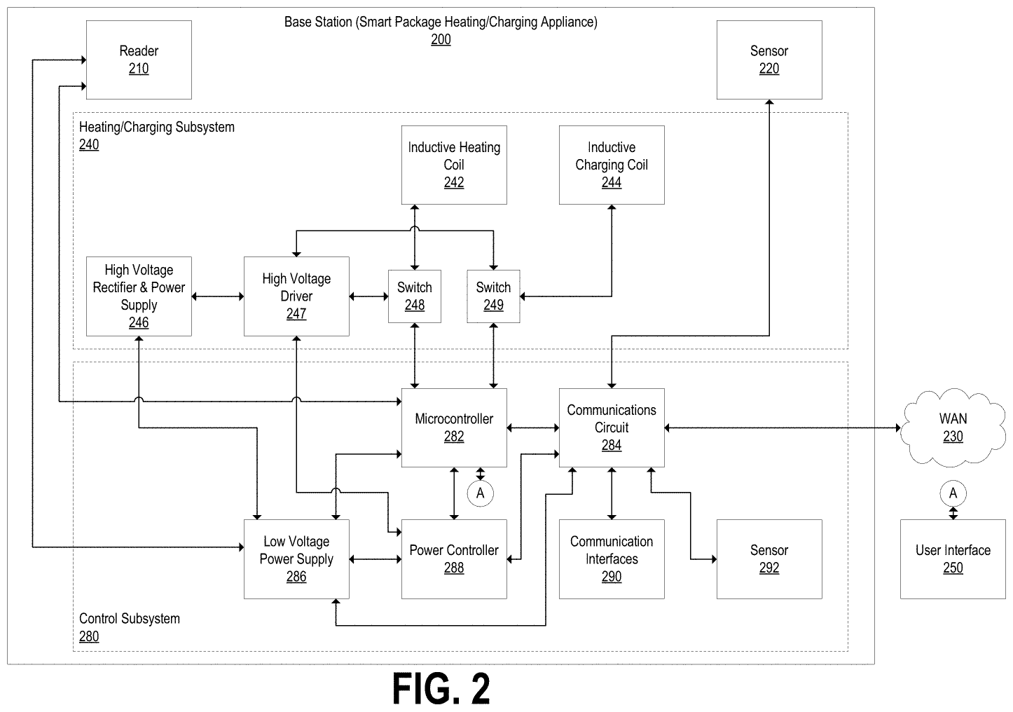

FIG. 2 shows an example of a base station. A base station 200 may comprise one or more of a smart package heating device, a charging device, and/or any other device for communications and/or operations with the smart package 100 described herein (and/or for communications and/or operations with any other device, such as a smart phone, an appliance, etc.). The base station 200 may comprise one or more of: a heating and/or charting subsystem 240, a control subsystem 280, a reader 210, a sensor 220 (e.g., a temperature sensor and/or any other sensor), and/or a light sensor and/or harvester (e.g., an integrated light harvesting circuit). The light sensor and/or harvester may use an I2C interface, and/or any other type of interface, for communication with one or more components of the base station 200. The base station 200 may communicate with the smart package 100. The base station 200 may communicate with the smart package 100, for example, to heat contents (e.g., food, beverage, and/or any other substance) within or near/adjacent to the smart package 100.

The base station 200 may comprise a reader 210. The base station 200 may use the reader, for example, to communicate with the antenna 110 (e.g., via RF) of the smart package 100. The reader 210 may comprise an optical simulator (e.g., pulsed laser) to provide energy to the antenna 110. The reader 210 may comprise an RF simulator, for example, to provide energy (e.g., electromagnetic energy) to the antenna 110. The antenna 110 may receive energy from the reader 210 (e.g., electromagnetic energy, energy from a pulsed laser, and/or any other energy). The antenna 110 may send an RF signal to the reader 210. The antenna 110 may send an RF signal, for example, based on the antenna 110 receiving energy from the reader 210. The RF signal may comprise an identifier (e.g., a unique identifier) that may be associated with the smart package 100. The identifier may be stored in the memory 112 and/or any other component and/or location.

The base station 200 may comprise a heating and/or charging subsystem 240. The heating and/or charging subsystem 240 may comprise one or more inductive heating coils (e.g., inductive heating coil 242) and/or one or more inductive charging coils (e.g., inductive charging coil 244). One or more inductive heating coils 242 and one or more inductive charging coils 244 may be integrated as a single unit (e.g., a heating and charging coil). The one or more inductive heating coils 242 and/or the one or more inductive charging coils 244 may be separate. The one or more inductive heating coils 242 and/or the one or more inductive charging coils 244 may be selectively activated and/or energized by one or more of: a switch 248 and/or a switch 249. The one or more inductive heating coils 242 and/or the one or more inductive charging coils 244 may be driven by a high voltage driver 247 (e.g., via switch 248 and/or via switch 249). The high voltage driver 247 may receive rectified high voltage power from a power supply 246. The power supply 246 may comprise a high voltage rectifier and power supply. The one or more inductive heating coils 242 may be positioned/located to provide energy to the bottom and/or one or more sides of a smart package 100. The one or more inductive heating coils 242 may be positioned/located to provide energy to the bottom and/or sides of a smart package 100, for example, to provide rapid cooking times, such as if the base station 200 may be configured for rapid cooking (e.g., operating as a hot food vending machine and/or any other rapid delivery system of heated products). A half bridge driver and/or a full bridge driver may be used to drive the configuration of the heating and/or charging subsystem 240. The configuration of the heating and/or charging subsystem 240 may be designed for 19 volt (V) direct current (DC) operation and/or any other voltage level and/or operation (e.g., 120 V alternating current (AC) operation, 240 VAC operation, 12 VDC operation, 9 VDC operation, 5V DC operation, etc.). The configuration of the heating and/or charging subsystem 240 may be adjustable to operate with lower and/or higher voltages. The configuration of the heating and/or charging subsystem 240 may use a switched external power supply (e.g., for added safety).

The base station 200 may comprise a control subsystem 280. The control subsystem 280 may comprise one or more of: a microcontroller 282, a communications circuit 284, a low voltage power supply 286, a power controller 288 (e.g., a wireless power controller), one or more communication interfaces 290 (e.g., WiFi interface(s), BTLE interface(s), and/or any other interface(s)), and/or a sensor 292 (e.g., an ambient temperature sensor). The control subsystem 280 may control the heating and/or charging subsystem 240 and/or the reader 210. The microcontroller 282 may comprise a microprocessor and/or any other processor. The microcontroller 282 may be powered by the low voltage power supply 286. The power controller 288 may communicate with a wireless device (e.g., the smart package 100) via the microcontroller 282, a communications circuit 284, and/or one or more communication interfaces 290. The power controller 288 may use the microcontroller 282 and/or a communications circuit 284 to communicate with a wireless device, for example, if a wireless device is to be charged (e.g., via the one or more inductive charging coils 244). The power controller 288 may use a Qi standard, and/or any other standard or procedure, for wireless charging. The power control 288 may be used for wireless charging and/or wired charging. The power controller 288 may comprise authentication capabilities. The power controller 288 may comprise authentication capabilities, for example, to determine if a device and/or a product (e.g., present at or near the base station 200) is authenticated for an operation (e.g., is a registered product, an approved product, a recognized product, etc.). The control subsystem 280 and/or the microcontroller 282 may determine if a rechargeable device (e.g., a smartphone and/or any wireless device), and/or if a smart package 100, is present at or near the base station 200. A signal (e.g., a ping signal) may be used to detect impedance changes in the one or more inductive heating coils 242 and/or in the one or more inductive charging coils 244. For example, the microcontroller 282 may send an indication for the signal and/or receive an indication of impedance changes in the one or more inductive heating coils 242 and/or in the one or more inductive charging coils 244. The signal may be used to determine the presence of, and/or identify an object, placed on/in and/or near the base station 200. The base station 200 may deliver power to a charging device, for example, based on the signal.

The base station 200 may harvest power using the reader 210. The reader 210 may comprise an antenna (e.g., RFID antenna, NFC antenna, and/or any other antenna). Power may be harvested from the reader 210 using a rectifier (e.g., an asynchronous rectifier and a tuned resonant frequency). Power harvested from the reader 210 may be stored to power the microcontroller 282 and/or a switch capacitor network. The microcontroller 282 may comprise computer readable instructions to power one or more components, such as I2C components (e.g., sensor 220), for example, based on available power (e.g., harvested power).

The base station 200 may comprise a user interface 250. The user interface 250 may be supported by the microcontroller 282. The base station 200 may comprise a display device (not shown). The base station 200 may display the user interface 250 via the display device. The user interface 250 may output one or more indications, such as a status bar (e.g., heating status), which may be displayed at the display device. The base station 200 may comprise an audio output device (e.g., a speaker and/or amplifier). The user interface 250 may output simulated voice responses and/or other indications via the audio output device. The base station 200 may comprise one or more input devices. The one or more input devices may comprise one or more of: a touchscreen device, a microphone (e.g., with voice recognition support), a pointing device, a button, a key/keypad, and/or any other input device. The user interface 250 may receive one or more inputs via the one or more input devices. The one or more communication interfaces 290 may be used for communications with one or more of: the display device, the audio output device, and/or the input device.

The control subsystem 280 may comprise one or more communications circuits (e.g., communications circuit 284). The communications circuit 284 may enable communication capabilities, Internet of Things (IOT) interface capabilities, 3^{rd} generation partnership project (3GPP) wireless communication capabilities (e.g., Long-Term Evolution (LTE), LTE-Advanced, New Radio (NR)/5G, 6G, and/or any other 3GPP generation), IEEE 802.11 wireless communication capabilities, and/or security and/or authentication capabilities for the base station 200. The communications circuit 284 may enable capabilities accessed by a wide area network (WAN) 10 and/or any other network. The WAN 10 may be accessed by the base station 200, for example, to authenticate a smart package 100 and/or a rechargeable device (e.g., a smartphone and/or any other wireless device). Authentication of a smart package 100 and/or a rechargeable device may reduce and/or help to eliminate counterfeit products being used with the smart package 100. One or more databases and/or one or more web service servers may be accessed via the WAN 10. One or more databases and/or one or more web service servers may store one or more data sets. The one or more data sets may information and/or content related information for the smart package 100. One or more devices (e.g., user device, appliance, smartphone, wireless device, etc.) may access the one or more databases and/or one or more web service servers via the WAN 10. The one or more devices may access the base station 200 via the WAN 10. The one or more devices may store and execute one or more applications to communicate with the base station 200 (e.g., via the WAN 10, NFC, Bluetooth, WiFi, and/or any other type of communication).

The base station 200 and/or the smart package 100 may use one or more heating profiles. The one or more heating profiles may be stored in the memory 112 of the communication module 106 of the smart package. Additionally or alternatively, the one or more heating profiled may be stored in memory of the base station 200. A heating profile may comprise one or more product cooking data sets. A heating profile may comprise parameters (e.g., product cooking data sets) that the control subsystem 280 may use to heat the smart package 100. For example, a heating profile may comprise: a start at ambient temperature, a first temperature set point, a holding temperature, a time required to heat a product (e.g., a time to pop popcorn, a time to re-heat coffee in a mug, a time to cook a frozen dinner, etc.), and/or a temperature corresponding to an “off”/inactive status of the base station 200. The start at ambient temperature may comprise a first temperature setpoint with a required/expected energy to be used to heat a smart package 100. The holding temperature may comprise a second temperature setpoint with the required/expected energy to be used to heat a smart package 100 within the hold time. The product cooking data set may comprise the thermodynamic mass cooling of the smart package 100 over a time period. The thermodynamic mass cooling of the smart package 100 over a time period may be based on the volume of the smart package 100. The heating profile may comprise the expected heat applied to the smart package 100. The heating profile may be used to control operation of the base station 200. The heating profile may comprise a cool down time for the smart package 100. For example, the contents of the smart package 100 may be heated to a temperature above the specified consumption temperature. The smart package 100 may provide temperature information (e.g., from the one or more temperature sensors (e.g., 142, 144, 146)) to the base station 200, for example, based on the heating procedure. The temperature information may comprise a temperature threshold that may indicate if the smart package 100 is safe to touch. The temperature information may indicate if the contents of the smart package 100 have cooled to the specified consumption temperature. The heating profile may comprise an optimal temperature of the inductive receptor 170. The optimal temperature of the inductive receptor 170 may be tracked as a measured offset for the smart package 100. The optimal temperature of the inductive receptor 170 may be determined, for example, based on a measured offset for the smart package 100. The measured offset for the smart package 100 may be determined based temperature measurements from one or more of: the temperature sensor 142, the temperature sensor 144, the temperature sensor 146, the sensor 220 (e.g., an I2C temperature sensor), and/or the sensor 292 (e.g., an ambient temperature sensor). The measured offset may be determined based on a calibration procedure. The calibration procedure may occur during manufacturing, assembly, and/or packaging of the smart package 100.

The one or more heating profiles may be accessed from a remote location and/or from a remote device. The one or more heating profiles may be accessed from a database server (e.g., via the WAN 10), for example, based on an identifier (e.g., a unique identifier) associated with the smart package 100 (e.g., stored in the memory 112). A heating profile may comprise one or more of: a stock-keeping unit (SKU) identifier (ID), content data of the smart package 100 (e.g., name, viscosity, specific gravity, % of liquid, and/or any other characteristic of its contents), package data of the smart package 100 (fill accuracy, change over time, altitude offsets, limits, base pressure, and/or any other characteristic of the package), a target heating temperature of the smart package 100, encryption codes for an authentication procedure, a use status (e.g., used, not used) indicator of the smart package 100, production date, production batch, intervention (e.g., stirring, turning, moving) intervals, a maximum temperature of the smart package 100, expiration date of the contents of the smart package 100, heating instructions for the smart package 100, a frequency of operation of the one or more inductive heating coils 242, an amplitude of operation of the one or more inductive heating coils 242, power profile over temperatures (e.g., surface and/or RFID tag), operating offsets based on an ambient temperature sensor (e.g., sensor 292), temperature of the one or more temperature sensors (e.g., 142, 144, 146) and/or the inductive receptor 170 vs. time, and/or temperature of the sensor 220 in the base station 200 (e.g., an I2C temperature sensor) vs. time. The altitude and the temperature of the ambient temperature sensor 292 may be stored as offsets (e.g., rather than actual altitude and temperature measurements) to a transform function. The temperature of the inductive receptor 170 may be determined, for example, based on measuring operating characteristics (e.g., temperature measured by one or more of the temperature sensor 142, the temperature sensor 144, the temperature sensor 146, the sensor 220, and/or the sensor 292). The offsets of the temperature measured by the sensor 220 of the base station 200 and one or more temperatures measured by sensors of the smart package 100 (e.g., 142, 144, 146) may be stored and/or used to determine the temperature of the inductive receptor 170.

A heating profile may be determined based on one or more procedures. The one or more procedures may be performed during manufacturing, assembly, and/or packaging of the smart package 100 and/or of the base station 200. A smart package 100 may be tested and/or calibrated for an optimal cooking operation (e.g., during manufacturing). A manufacturer may use a test platform to perform one or more heating and/or heating related operations (e.g., a series of predetermined heating or heating related operations) on a smart package 100. The manufacturer may perform the one or more heating and/or heating related operations on the smart package 100, for example, in order to determine one or more thermodynamic response characteristics. Data determined (e.g., from one or more manufacturing steps) may comprise data representing placement of the smart package 100 on the base station 200 in one or more offsets (e.g., physical offsets at 0.1″ increments or any other dimensional increment or range). Response characteristics of the smart package 100 at the one or more offsets may be determined. The response characteristics of the smart package 100 may be saved or associated with the smart package 100. The response characteristics of the smart package 100 may be stored (e.g., in the memory 112) as package offsets, temperature and/or power adjustments, and/or expected ranges of operation and/or variations. The response characteristics of the smart package 100 may be used to modify operational curves and/or correlated data representing thermodynamic response characteristics of the smart package 100. If the response characteristics of the smart package 100 are indicated (e.g., identified) by the base station 200, the placement (e.g., centered or offset) of the smart package 100 on the base station 200 may be determined and/or the control parameters of the heating profile may be adjusted. The response characteristics of the smart package 100 may be stored in test equipment or any other device. The response characteristics of the smart package 100 may be reduced to one or more simplified data curves and/or correlations (e.g., files with table data) for storage in the communication module 106 and/or storage on a server in association with an identifier (e.g., a unique identifier) for the smart package 100. The response characteristics of the smart package 100 may be used by the control subsystem 280 to control heating of the smart package 100, for example, based on (e.g., according to) the heating profile.

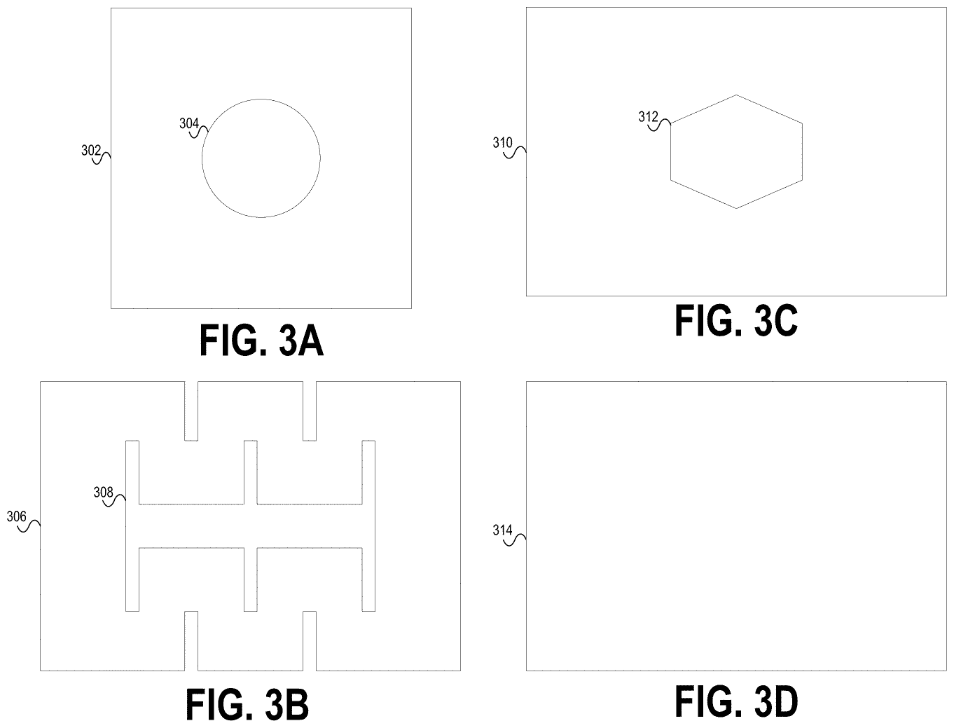

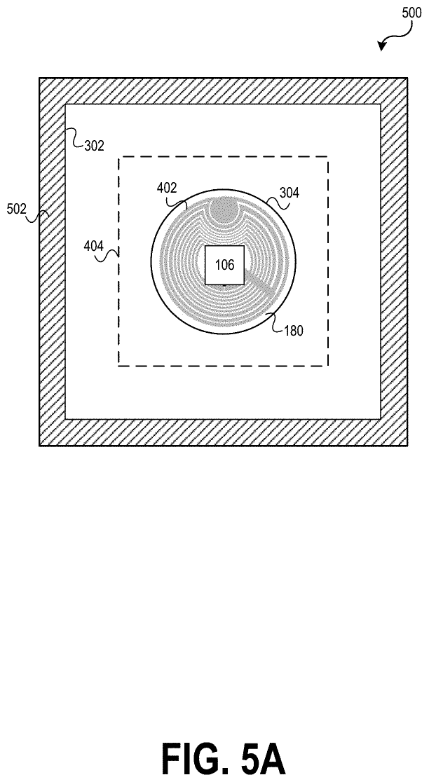

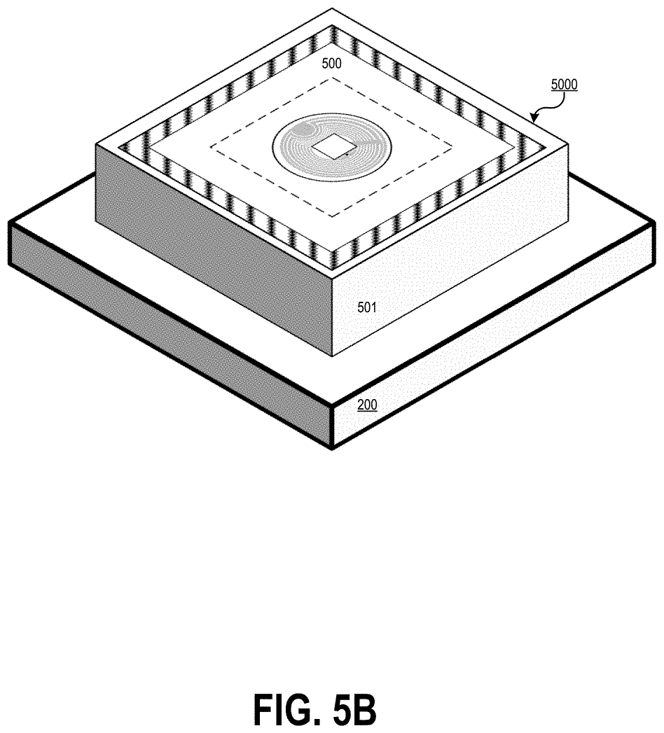

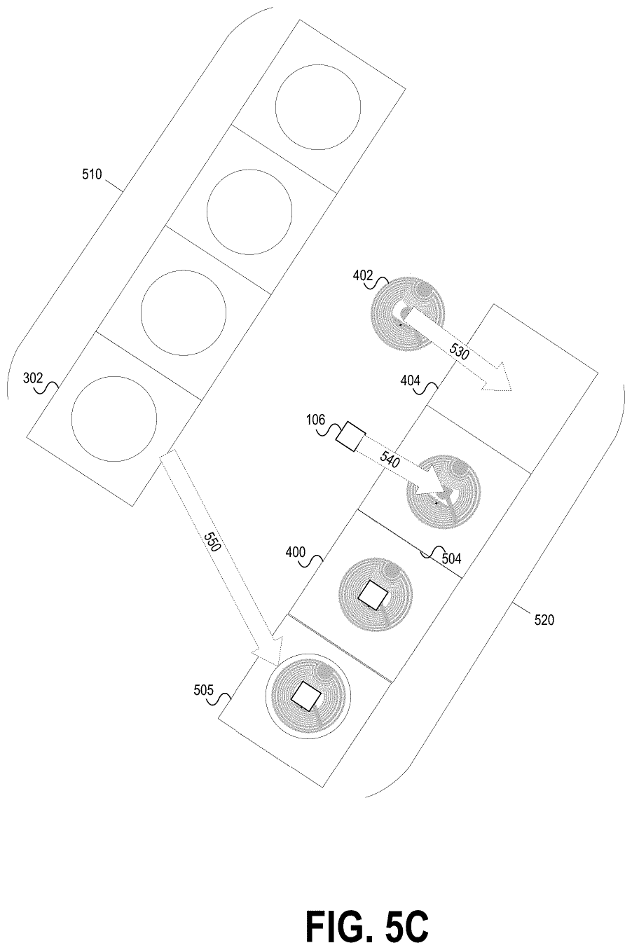

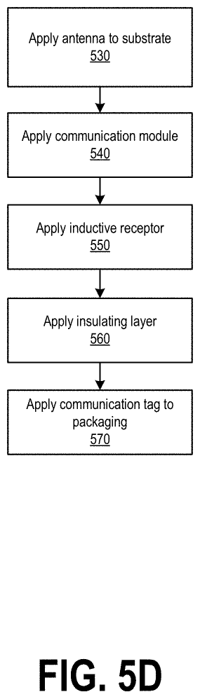

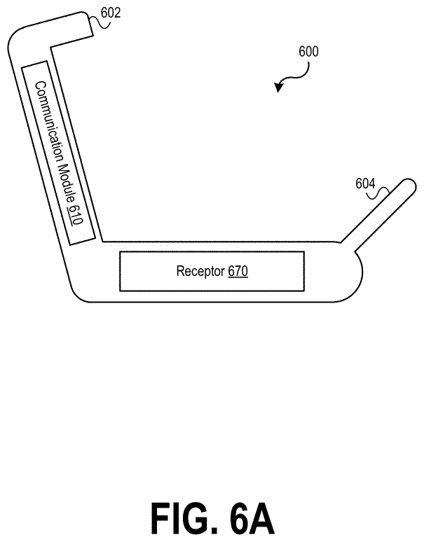

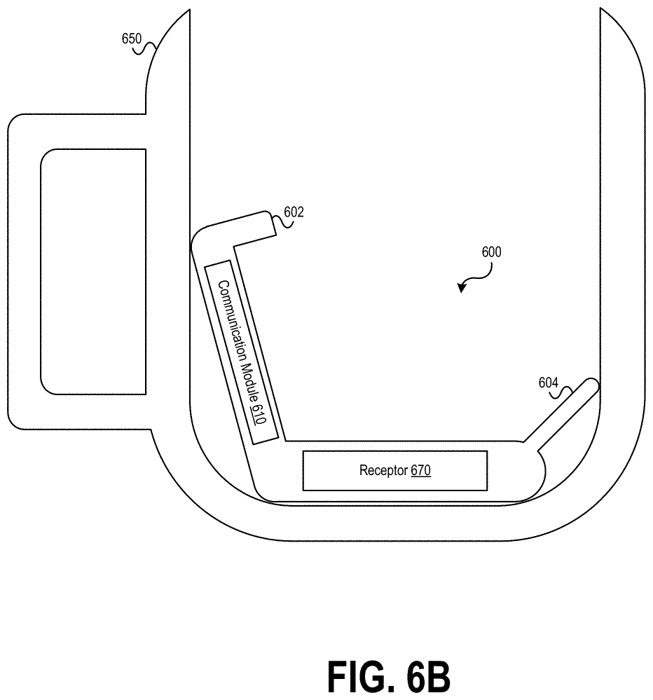

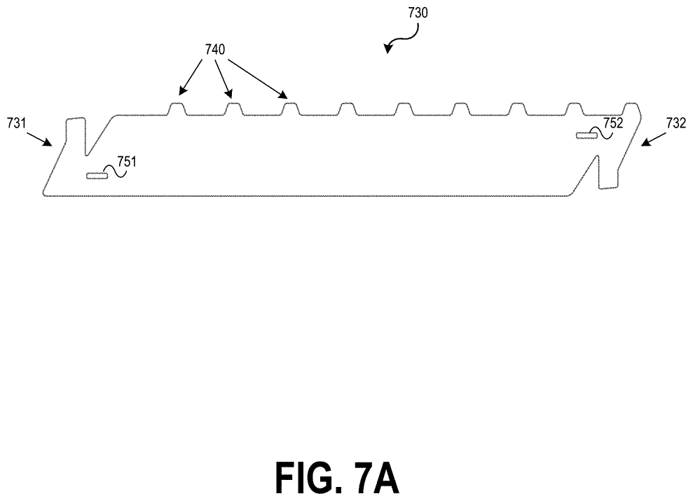

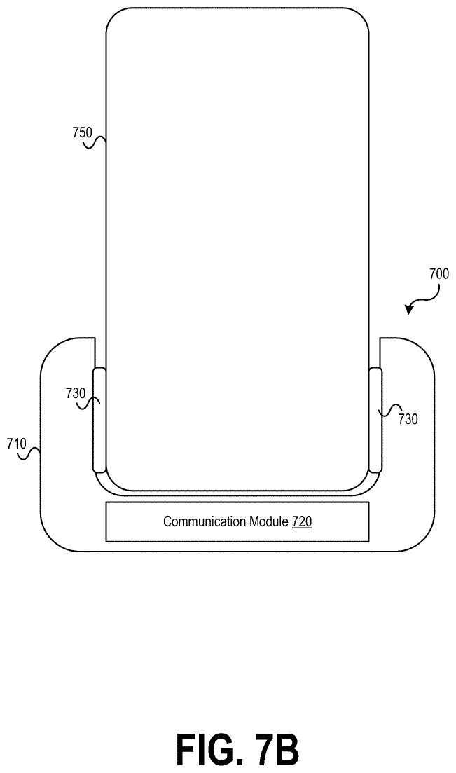

FIGS. 3A, 3B, 3C, and 3D each show an example of an inductive receptor. FIG. 3A shows an inductive receptor 302 comprising a spherical-shaped void 304 (e.g., a cutout). FIG. 3B shows an inductive receptor 306 comprising an irregular-shaped void 308 (e.g., a cutout). FIG. 3C shows an inductive receptor 310 comprising an irregular hexagon-shaped void 312 (e.g., a cutout). FIG. 3D shows an inductive receptor 314 that does not comprise a void (e.g., a cutout). An inductive receptor of any shape and/or size may be used as any of the receptors described herein. An inductive receptor may comprise a shape and/or size that may be based on a type of food, liquid, and/or any other substance that may be desired to be heated, based on a type of device to be used for heating (e.g., such as the smart package 100 described with respect to FIG. 1, the smart package assembly 5000 described with respect to FIG. 5B, the smart accessory 600 described with respect to FIGS. 6A-6B, and/or the smart apparatus 700 described with respect to FIGS. 7A-7B), and/or based on the location of the inductive receptor relative to a communication module. For example, an inductive receptor may be used to transfer heat along its surface based on the size and/or shape of the inductive receptor and/or any voids in the inductive receptor. An inductive receptor shaped with a void comprising various cutouts, such as the inductive receptor 306, may provide more even distribution of heat at various locations of a food object adjacent to the inductive receptor (e.g., within a package comprising the inductive receptor 306) than an inductive receptor without a void comprising such cutouts, such as the inductive receptor 314. Additionally or alternatively, an inductive receptor shaped with a void comprising various cutouts, such as the inductive receptors 302, 306, and/or 310, may provide improved communications (e.g., to/from a communication module such as the communication module 106) that may be located within the void. For example, a void in an inductive receptor may enable radio frequency (RF) communications to be sent/received (e.g., between the communication module and a base station such as the base station 200) with reduced interference (e.g., minimal, low, or no interference) by the inductive receptor. An inductive receptor without a void, such as the inductive receptor 314, may provide desired distribution of heat for a liquid (e.g., coffee, water, etc.). An inductive receptor without a void, such as the inductive receptor 314, may achieve desired operation in a device in which a communication module is not above (e.g., not directly on top of) the inductive receptor (e.g., such as the smart accessory 600, comprising a receptor 670 that is in a different location from a communication module 610, as described with respect to FIGS. 6A-6B). An inductive receptor may be inserted into packaging of a food product (e.g., wrapper, product container, etc.), for example, to provide desired heat transfer for heating and/or cooking the food product. An inductive receptor may be printed on packaging of a food product (e.g., wrapper, product container, etc.).

The receptor 170 of the smart package 100 described herein with respect to FIG. 1 may comprise one or more of the inductive receptor 302, the inductive receptor 306, the inductive receptor 310, the inductive receptor 314, and/or any other inductive receptor. While the inductive receptor 302, the inductive receptor 306, the inductive receptor 310, and the inductive receptor 314 are provided as examples, the receptor 170 of the smart package 100 may comprise any shape (e.g., spherical, rectangular, irregular, etc.) and/or may comprise any quantity, shape, and/or size of void(s) (e.g., cutouts). The inductive receptor (e.g., 302, 306, 310, 314) may be composed of one or more inductive materials (e.g., a material that may be heated via induction). For example, the inductive receptor (e.g., 302, 306, 310, 314) may be composed of a metalized material such as printed, sputter-coated, and/or vapor-deposited aluminized material. The inductive receptor (e.g., 302, 306, 310, 314) may comprise one or more layers. The one or more layers may be composed of one or more inductive materials. Each layer of the inductive receptor (e.g., 302, 306, 310, 314) may enable specific heating characteristics, for example, based on the composition of each layer. A layer of the inductive receptor (e.g., 302, 306, 310, 314), for example, may be substantially non-conductive at a frequency (or a first range of frequencies), while being substantially conductive at another frequency (or a second range of frequencies). For example, a first inductive layer of the inductive receptor (e.g., 302, 306, 310, 314) may be heated via induction at first frequency (e.g., 100 kHz or any other frequency or range of frequencies). A second inductive layer of the inductive receptor (e.g., 302, 306, 310, 314) may be heated at a second frequency (such as via microwaves, e.g., 1 GHz, or any other frequency or range of frequency). The layer(s) of the inductive receptor (e.g., 302, 306, 310, 314) may be of varying dimensions (e.g., thickness, width, and/or length). For example, a first inductive layer of the inductive receptor (e.g., 302, 306, 310, 314) may be composed in a first shape/package (e.g., a square, such as the inductive receptor 302 in FIG. 3A). A second inductive layer may be composed of a second shape/package (e.g., a circle). The combination of multiple layers of the inductive receptor (e.g., 302, 306, 310, 314) may enable variable heating (e.g., variable temperature and/or variable distribution of heating) of the inductive receptor (e.g., 302, 306, 310, 314) according the configuration and/or material(s) of the layer(s). A smart package 100 may be heated in a specific pattern comprising specific temperature ranges, for example, if the inductive receptor (e.g., 302, 306, 310, 314) is coupled to (e.g., adjacent and/or within a threshold distance from) the smart package 100 and/or if the inductive receptor (e.g., 302, 306, 310, 314) is composed of more than one layer (e.g., with layers comprising different heating characteristics).

The inductive receptor (e.g., 302, 306, 310, 314) may comprise one or more voids (e.g., 304, 308, 312). A void (e.g., 304, 308, 312) may comprise one or more open/vacant areas and/or cavities within the structure of the inductive receptor (e.g., 302, 306, 310, 314). The inductive receptor (e.g., 302, 306, 310, 314) may shunt thermal energy away from the void (e.g., 304, 308, 312), for example, based on the shape of the void (e.g., 304, 308, 312). A measured temperature in the area of the void (e.g., 304, 308, 312) may be a lower temperature relative to the temperature of the inductive receptor (e.g., 302, 306, 310, 314), for example, if the inductive receptor (e.g., 302, 306, 310, 314) is heated via induction. The inductive receptor (e.g., 302, 306, 310, 314) may shunt the induction field from the void (e.g., 304, 308, 312), for example, if the inductive receptor (e.g., 302, 306, 310, 314) is subjected to an induction field (e.g., generated via the base station). By shunting the induction field away from the void (e.g., 304, 308, 312), the induction field in the area of the void (e.g., 304, 308, 312) may be a lower strength induction field relative to the induction field present at the area of the inductive receptor (e.g., 302, 306, 310, 314). A ferrite material may be used to separate an inductive receptor (e.g., the receptor 314) and a communication module (e.g., the communication module 106 in FIG. 1), for example, if the inductive receptor (e.g., 314) does not comprise a void. An inductive receptor that comprises a void (e.g., 304, 308, 312), such as the inductive receptors 302, 306 and/or 310, may not require use of a ferrite material, which may reduce cost and/or reduce time for manufacturing.

An RFID tag (e.g., comprising the communication module 106 and/or the antenna 110) may be placed on top of, below, and/or within a void of an inductive receptor. The placement of an RFID tag (e.g., comprising the communication module 106 and/or the antenna 110) in relation to an inductive receptor may be based on the location and/or intensity of heat applied across the inductive receptor. For example, an RFID tag (e.g., comprising the communication module 106 and/or the antenna) may be placed on top of a center portion of an inductive receptor that may lack a void (e.g., the inductive receptor 314). An RFID tag (e.g., comprising the communication module 106 and/or the antenna 110) may be placed within a void of an inductive receptor (e.g., 302, 306, 310) that comprises a void (e.g., 304, 308, 312). The shape and/or location of the RFID tag (e.g., comprising the communication module 106 and/or the antenna 110) may be based on the shape of the void (e.g., 304, 308, 312). For example, the RFID tag (e.g., comprising the communication module 106 and/or the antenna 110) may be inserted in approximately the middle of the void 302 of the inductive receptor 302, and/or in approximately the middle of the void 312 of the inductive receptor 310. Additionally or alternatively, an RFID tag may be shaped in an elongated shape for placement in a void of an inductive receptor (e.g., 206) comprising an elongated void (e.g., 308). By combining an RFID tag (e.g., comprising the communication module 106 and/or the antenna 110) with an inductive receptor in the manner described herein, improved operation may be achieved. For example, communications may be received and/or sent (e.g., between the communication module 106 and a base station, such as the base station 200) with increased likelihood of success by avoiding RF interference that may otherwise be caused by a heating operation. At least some inductive receptors may absorb RF communications to/from an antenna, for example, if the receptor is too close to the antenna and/or not sufficiently isolated from the antenna. The examples described herein may avoid absorption of RF communications by an inductive receptor, which may improve communications (e.g., for sending indications of temperature and/or other sensing information that may be relevant to heating/cooking operation and/or safety enhancements). Additionally or alternatively, the examples described herein may reduce a likelihood of damage to a communication module (e.g., the communication module 106) during a heating process, which may provide improved performance, enhanced durability, and/or greater longevity of operability. Additionally or alternatively, the examples described herein may reduce overvoltages, that may otherwise reduce performance (e.g., reduce reliability and/or reduce accuracy) and/or lead to damage and/or failure. For example, overvoltage may be reduced by placement of an antenna with a void of an inductive receptor, as described herein.

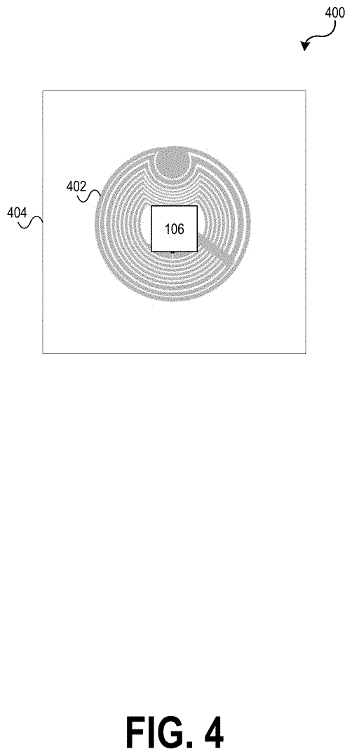

FIG. 4 shows an example of a communication tag (e.g., RFID tag). A communication tag 400 (e.g., RFID tag) may comprise a communication module. For example, the communication tag 400 may comprise the communication module 106 described with respect to FIG. 1, which may take the form of an integrated circuit and/or any combination of electronic components generally shown as the communication module 106 in FIG. 4. The communication module 106 may be placed within the void 304 of the inductive receptor 302. As shown in FIG. 4, the communication module 106 may be applied to a substrate layer 404, for example, by placing the communication module 106 on top of an antenna 402 (e.g., wherein the antenna 402 may be applied to the substrate layer 404). The communication tag 400 may comprise a sticker. For example, an adhesive may be applied on top of (and/or on the bottom of) the substrate layer 404 of the communication tag 400, for example, for adhesive coupling with one or more inductive receptors and/or with one or more insulating layers (e.g., such as with the inductive receptor 302 and/or such as with the inductive receptor/protective layer 502, as described herein with respect to FIG. 5A).

The communication tag 400 may be included in the smart package 100 as described herein with respect to FIG. 1. For example, the communication tag 400 may be coupled with an inductive receptor (e.g., the inductive receptor 302 described with respect to FIG. 3A) to form a smart tag. The communication tag 400 (e.g., configured as a smart tag) may enable a smart package (such as the smart package 100) to communicate with the base station 200 described herein with respect to FIG. 2. The communication tag 400 may enable the smart package 100 to control, and/or to be controlled by, the base station 200. The communication tag 400 may comprise an antenna 402. The antenna 402 may comprise the antenna 110 described herein with respect to FIG. 1. The antenna 402 may enable wireless communications via NFC, radio-frequency identification (RFID), and/or any other wireless communication method/protocol (e.g., Bluetooth, WiFi, etc.). The communication tag 400 may comprise a substrate layer 404 (e.g., a non-conductive substrate layer such as paper, plastic, and/or any other material or combination thereof). The antenna 402 may be printed on the substrate layer 404. The antenna 402 may be printed on the substrate layer, for example, using conductive ink. Additionally or alternatively, the antenna 402 may be composed of patterned and/or cut material (e.g., foil and/or any other conductive material). The communication tag 400 may comprise one or more application-specific integrated circuits (ASICs). The communication tag 400 may comprise one or more ASICs, for example, comprising and/or in combination with one or more of the components of the communication module 106. For example, the communication tag 400 may be the communication module 106, which may comprise one or more ASICs. The one or more ASICs may comprise each of the components of the communication module 106 described with respect to FIG. 1.

FIG. 5A shows an example of an assembly comprising an inductive receptor and a communication module. The communication tag 400 described with respect to FIG. 4 may be combined with an inductive receptor, such as the inductive receptor 302 described with respect to FIG. 3A (or any other inductive receptor described herein), in an assembly such as a package and/or tag 500. The package/tag 500 may comprise the communication tag 400 (e.g., comprising the antenna 402 and the substrate layer 404, as described with respect to FIG. 4), the inductive receptor 302 comprising the void 304 (e.g., as described with respect to FIG. 3), the insulating spacer 180 (e.g., as described with respect to FIG. 1), and/or a second inductive receptor/protective layer 502. The second inductive receptor/protective layer 502 may be optional. The second inductive receptor/protective layer 502 may comprise an inductive receptor and/or a protective layer. The second inductive receptor/protective layer 502 may comprise the spacer 180 as described herein with respect to FIG. 1. The second inductive receptor/protective layer 502 may comprise any shape or size. For example, the second inductive receptor/protective layer 502 may be larger (e.g., in length and/or width) than that inductive receptor 302 (such as shown in FIG. 5A), or the second inductive receptor/protective layer 502 may be smaller (e.g., in length and/or width) than the inductive receptor 302. The second inductive receptor/protective layer 502 may comprise packing of a food product and/or a beverage product. For example, the second inductive receptor/protective layer 502 may comprise a shape corresponding to the shape of a food product and/or a beverage product. The antenna 402 (e.g., of the communication tag 400) may be located within the void 304 of the inductive receptor 302. The insulating spacer 180 may separate the antenna 402 from the inductive receptor 302. The insulating spacer 180 may be composed of a non-conductive material (e.g., paper, plastic, composite, glass, and/or any other non-conductive material or combination thereof). The inductive receptor 302 may be composed as a first structure and the communication tag 400 may be composed as a second structure, such that the package/tag 500 may be formed by coupling the first structure (e.g., the inductive receptor 302) to the second structure (e.g., the communication tag 400), with the substrate 404 serving as the intermediary medium. In the manufacturing process of package 500/tag, for example, the inductive receptor 302 and the communication tag 400 (coupled (e.g., by a conductive epoxy) to the substrate 404) may be coupled to form the package/tag 500. While FIG. 5A shows the package/tag 500 comprising the inductive receptor 302, any receptor described herein may be used as an inductive receptor in the package/tag 500. Additionally or alternatively, while FIG. 5A shows the package/tag 500 comprises an inductive receptor comprising void 304, any one or more voids (e.g., any quantity, shape, and/or size of void(s)) may be applied to an inductive receptor in the package/tag 500. Additionally or alternatively, while FIG. 5A shows the package comprising the antenna 402, any antenna described herein (e.g., any size, shape, pattern, and/or configuration) may be used as an antenna in the package/tag 500.

The package/tag 500 may be coupled to and/or integrated with a smart package. For example, the package/tag 500 may be coupled to and/or integrated with the smart package 100, which may comprise the communication module 106, the inductive receptor 170, and/or the insulating spacer 180 described herein with respect to FIG. 1. The package/tag 500 may be coupled to and/or integrated with the smart package assembly 5000 as described herein with respect to FIG. 5B. The package/tag 500 may enable heating of the smart package 100, such as via the inductive receptor 302 (or any other receptor described herein). The package/tag 500 may enable wireless communications (e.g., with the base station 200 or any other device), such as via the communication tag 400. The inductive receptor 302 and the communication tag 400 may be combined in the package/tag 500 such that the inductive receptor 302 may be heated via induction (e.g., via the base station 200 or any other device). The communication tag 400 may communicate (e.g., wirelessly or wired), such as by using an antenna (e.g., reader 210 of the base station 200). The inductive receptor 302 may shunt thermal energy from the area of the void 304 (e.g., within the communication tag 400), for example, if the package/tag 500 is subjected to an induction field (e.g., via activation of the induction heating coil 242 of the base station 200). By shunting thermal energy away from the communication tag 400, the inductive receptor 302 may prevent thermal damage (e.g., overheating) to the communication tag 400. The inductive receptor 302 may shunt the induction field away from the area of the communication tag 400 and the antenna 402. By shunting the induction field from the communication tag 400 and/or the antenna 402, one or more components, such as ASIC(s), associated with the communication tag 400 may reduce the likelihood (e.g., avoid) damage from electromagnetic sources (e.g., the induction heating coil 242 of the base station 200). The thickness of the insulating space may vary, for example, based on a type of communications. For example, for wireless communications (e.g., via NFC, via RFID, etc.) between the antenna 402 and the reader 210, the thickness of the insulating spacer 180 may be determined (e.g., adjusted) based on one or more of: a desired read distance for the antenna 402, and/or a capability (e.g., capacity) of the inductive receptor 302 to shunt thermal and/or electromagnetic energy. For example, the thickness of the insulating spacer 180 may be increased to increase the communication distance (e.g., read distance) between the communication tag 400 and the reader 210.

The thickness of the insulating spacer 180 may be determined (e.g., adjusted) based on one or more of: a size of the antenna 402, a size of the reader 210, a distance between the antenna 402 and the reader 210, an electromagnetic field strength (e.g., of the field generated by the base station 200) in the area of the communication tag 400, a resistivity of the inductive receptor 302, a permeability of the inductive receptor 302, and/or a thickness of the inductive receptor 302. In some examples, the thickness of the insulating spacer 180 may be greater (e.g., increased) if one or more of the inductive receptor 302 and/or the communication tag 400 is/are oversized.

The communication tag 400 and/or the antenna 402 may be coupled in various configurations. For example, the communication tag 400 and/or the antenna 402 may be coupled to the package/tag 500 such that the communication tag 400 and/or the antenna 402 may be located inside or outside of the area of inductive receptor 302. The communication tag 400 and/or the antenna 402 may be coupled to the package/tag 500 such that the communication tag 400 and/or the antenna 402 may be located inside or outside of the area of the void 304. Additionally or alternatively, the communication tag 400 may be coupled to a sidewall of the smart package 100, such that the communication tag 400 may be located orthogonal to the inductive receptor 302, and/or the antenna 402 may be coupled to the package/tag 500 within the void 304. Additionally or alternatively, the communication tag 400 may be coupled to the package/tag 500 within the area of the void 304, and/or the antenna 402 may be coupled to a sidewall of a smart package 100. Interference may be reduced between the antenna 402 and one or more inductive heating coils 242, for example, based on the location of the antenna 402. A decoupled arrangement of the inductive receptor 302 and the communication tag 400 within the package/tag 500 may provide, for example, reduced interference.

The inductive receptor 302 may be conductive, or may be nonconductive, at the frequency of operation of the antenna 402 of the communication tag 400. The substrate 404 of the communication tag 400 may be located between one or more layers of the inductive receptor 302. The substrate 404 of the communication tag 400 may be coupled between a first layer of inductive receptor 302 and a second layer (or any other quantity of layers, such as 2, 3, 4, etc.) of inductive receptor 302, for example, if the layering of the substrate 404 within the first layer and second layer (or any other quantity of layers, such as 2, 3, 4 etc.) of the inductive receptor 302 does not interfere with operation of the communication tag 400 and/or the antenna 402. Additionally or alternatively, the substrate 404 of the communication tag 400 may be located above or below (e.g., on the top of or on the bottom of) one or more layers of the inductive receptor 302.

The insulating spacer 180 may separate the inductive receptor 302 and one or more of the communication tag 400 and/or the antenna 402. The insulating spacer 180 may be composed of a ferrite material. The ferrite material may be formed by a reaction of ferric oxide (e.g., iron oxide) with a metal, such as one or more of: magnesium, aluminum, barium, manganese, copper, nickel, cobalt, and/or iron. The insulating spacer 180 may be composed of any material comprising a magnetic property. If the insulating space 180 is composed of a ferrite material, coupling and/or interference between the inductive receptor 302 and the communication tag 400 may be reduced, for example, relative to an insulating spacer 180 that is not composed of a ferrite material. The thickness of the ferrite material may be small and/or composed from a low saturation ferrite material. Application of a ferrite material as the insulating spacer 180 (e.g., to separate the inductive receptor 302 and antenna 402 of the communication tag 400) in a low energy field (e.g., for NFC communication), for example, may reduce a distance (e.g., inhibit coupling) between the inductive receptor 302 and the antenna 402. An insulating spacer 180 composed of ferrite material may saturate in the presence of a high energy induction field (e.g., from the base station 200), for example, which may enable the inductive receptor 302 to more effectively shunt the induction field away from the area of the communication tag 400 (and antenna 402).

The package/tag 500 may be designed for various applications. The package may be durable and/or designed for multiple uses (e.g., 5, 10, 20, 50, 100, or any other quantity of repeated instances of heating). The package/tag 500 may be non-durable and/or designed for a single use or other low quantity of uses (e.g., fewer than 20, 10, 5, 2, or any other quantity of repeated instances of heating). The package/tag 500 may be intentionally damaged (e.g., before, during, or after use) to render the package/tag 500 inoperable. For example, the package/tag 500 may be intentionally damaged to function in a single use application (e.g., as disposable food packaging), and/or after intentionally damages after a particular quantity of uses (e.g., for quality assurance purposes). The package/tag 500 may be intentionally damaged, for example, based on a signal received from the base station (e.g., indicating a burst of high heat for the purposes of destroying one or more portions of the package/tag 500). The package/tag 500 may be rendered inoperable via a device such as the base station 200 (e.g., by induction) and/or by internal mechanisms of the communication tag 400. The base station 200 may be configured to generate an induction field greater than the tolerance of the communication tag 400. One or more components (e.g., ASIC(s)) of with the communication tag 400 may be rendered inoperable (e.g., by overvoltage, by deformation, and the like), for example, if the communication tag 400 is subjected to an induction field greater than the tolerance of the respective component(s) and/or the communication tag 400. Additionally or alternatively, the communication tag 400 may comprise a fuse (and/or other component(s)), which may be designed for single use applications. The fuse (and/or other component(s)) may be configured to be electrically disconnected and/or rendered inoperable (e.g., break, blow, sever, etc.) at a certain time, for example, which may be associated with heating the smart package 100. The fuse (and/or other components) may be configured to be electrically disconnected and/or rendered inoperable, for example, after one or more sensors (e.g., one or more of the temperature sensor 142, the temperature sensor 144, the temperature sensor 146, and/or any other sensor) of the communication tag 400 reaches a value (e.g., a configured temperature) and/or based on one or more communications sent to the base station 200 (e.g., from the smart package 100). The package/tag 500 may comprise one or more instructions (e.g., one or more heating profiles) stored on a memory (e.g., memory module 112) that may become unreadable after a single use of the package/tag 500. The communication tag 400 may comprise protected instructions that may become unprotected, for example, after a single use of the package/tag 500 (e.g., a single use heating cycle). The unprotected instructions may comprise information that may cause the communication tag 400 of the package/tag 500 to become inoperable.

FIG. 5B shows an example of a smart package assembly and a base station. A smart package assembly 5000 may comprise a package/tag 500 (e.g., an RFID tag) and a container 501. The smart package assembly 5000 may comprise the smart package 100 (and/or one or more components thereof) described herein with respect to FIG. 1. The package/tag 500 may comprise the package/tag 500 described with respect to FIG. 5A. The container 501 may comprise any container for a substance to be heated, such as a food product, a beverage product, a wax product (e.g., scented wax), and/or the like. The container may comprise any shape, size, and/or material. For example, the container 501 may comprise a bag of popcorn to be heated, an all-in-one/ready-to-cook meal package (e.g., a TV dinner), a can of soup, a container of pasta, a packet of meat product, and/or any other substance to be heated. The container 501 may comprise the package/tag 500 on any surface (e.g., top, bottom, and/or any side). The package/tag 500 may be internal to the container, external to the container 501, within at least one layer of the container 501, and/or part of the container 501 itself (e.g., a wrapper, a cup, a bowl, a bag, and/or any other container). The package/tag 500 may operate as described herein with respect to any communication module, package, and/or tag described herein (e.g., RFID tag) and/or one or more portions thereof, for example, for the purpose of heating contents of the container 501. The container 501 may be placed on top of a device (e.g., the base station 200, such as shown in FIG. 5B) to heat the contents of the container 501. The base station 200 shown in FIG. 5B may operate as described herein with respect to FIG. 2. For example, the base station 200 may generate heat (e.g., via one or more inductive heating coils) that may be transferred, by an inductive receptor of the package/tag 500, to heat the contents of the container 501. The container 501 may be reusable, washable, disposable, and/or recyclable. The container 501 may comprise any suitable material that may accommodate the package/tag 500 and/or that may allow for safe heating of the contents of the container 501 (e.g., plastic, composite, glass, ceramic, silicone, rubber, cardboard, and/or any other material).

FIG. 5C shows an example of an assembly for a smart package/tag. FIG. 5D shows an example method for providing a smart package/tag. A communication tag 505 may comprise an RFID tag. The communication tag 505 may be coupled to a smart package (e.g., the smart package 100). The communication tag 505 may be applied to any surface and/or layer of a product (and/or a container for food, liquid, and/or any other substance) to be heated. The communication tag 505 may be manufactured and/or assembled among a plurality of communication tags 520. The plurality of communication tags 520 may be on a roll, a strip, and/or combined in any quantity of rows and/or columns (e.g., sheets, rolls of sheets, etc.). For example a roll, a strip, and/or a sheet may comprise the substrate 404 described with respect to FIG. 4. The substrate 404 may be for a single communication tag 520 or a plurality of communication tags 520. The substrate 404 may comprise markings, slits, and/or dividers 504, for example, for indication and/or removal of a communication tag 520 from the plurality of communication tags 520. A communication tag 505 may be assembled and/or manufactured by applying an antenna 402 to the substrate 404, such as shown at step 530. The antenna 402 may comprise the antenna 402 described with respect to FIG. 4. One or more of the antenna 402 may be applied to the substrate 404 in sequence and/or at the same time (or substantially the same time). A communication module 106 may be applied to the substrate 404, such as shown at step 540. The communication module 106 may comprise the communication module 106 described with respect to FIG. 1. The communication module 106 may be applied on top of (or below) the antenna 402. After application of the communication module 106, the substrate 404 may comprise the communication tag 400 described with respect to FIG. 4. An inductive receptor 302 may be applied to the substrate 404, such as shown in step 550. The inductive receptor 302 may comprise the inductive receptor 302 described with respect to FIG. 3. An insulating layer may be applied to the inductive receptor 302 and/or to the substrate 404, such as shown in step 560 (in FIG. 5D). The insulating layer may comprise the inductive receptor/protective layer 502, such as described with respect to FIG. 5A. The inductive receptor 302 (e.g., with or without the insulating layer) may be combined with a plurality of inductive receptors 510, such as on a roll, a strip, and/or a sheet. The inductive receptor 302 may be applied to the substrate 404 (e.g., comprising the communication tag 400) in sequence and/or at the same time (or substantially the same time) as other inductive receptors are applied to respective other portions of the substrate 400 (e.g., comprising respective other communication tags). For example, a roll, a strip, and/or a sheet of the receptors 510 may be applied to a roll, a strip, and/or a sheet of the communication tags 520. The receptors 510 may be applied to the communication tags 520 on a manufacturing line, for example, in which respective rolls/strips/sheets are adjoined, such as on a conveyer system. The substrate 404 may comprise a layer of packaging (e.g., internal or external portion of the actual packaging) of a food product, a beverage product, and/or any other product to be heated. Additionally or alternatively, the substrate 404 may comprise a layer to be applied to packaging of a food product, a beverage product, and/or any other product to be heated, such as by application of an assembled communication tag 505 to the packaging, as shown in step 570 (shown in FIG. 5D). The steps described with respect to FIGS. 5C and 5D may be performed in any order, and/or one or more steps may be removed, added, and/or repeated. For example, the communication tag 505 may be printed and/or manufactured in one or more stages. The communication tag 505 may be printed out of metal, for example, using one or more foils, and/or a communication module may be applied to the communication tag 505 after the tag is printed.

FIG. 6A shows an example of a smart accessory. A smart accessory 600 may comprise a communication module 610 and/or a receptor 670. The communication module 610 may comprise one or more of the communication module 106, the communication tag 400, the package/tag 500, and/or any communication module, package, and/or tag described herein (e.g., an RFID tag) and/or one or more portions thereof. The receptor 670 may comprise the inductive receptor 402, the inductive receptor 302, the inductive receptor 306, the inductive receptor 310, the inductive receptor 314, the receptor 170, and/or any receptor and/or concentrator described herein, and/or one or more portions thereof. The communication module 610 may perform one or more operations. The one or more operations may comprise, for example, wireless communications and/or wired communications. The one or more operations may comprise any of the operations described herein, such as those described with respect to the communication module 106, the communication tag 400, the package/tag 500, and/or any communication module, package, and/or tag described herein (e.g., an RFID tag), and/or one or more portions thereof. The communication module 610 may enable heating of the smart accessory 600 (e.g., via an induction heating device). The smart package accessory 600 may be controlled by a device (e.g., base station 200) via the communication module 610.

The communication module 610 may be arranged, within the smart accessory 600, at any location relative to the receptor 670, such as, for example, perpendicular, parallel, adjacent, and/or at any relative angle and/or distance. The communication module 610 and the receptor 670 may be oriented in a decoupled (e.g., perpendicular or substantially perpendicular) position (e.g., such as shown in FIG. 6A) and/or may be oriented with the communication module 610 located above, below, adjacent, parallel, or near the area of the receptor 670. The communication module 610 may be arranged at a distance and/or direction away from the receptor 670 such that an insulating spacer may not be required. Additionally or alternatively, an insulating spacer (not shown) may be inserted in between the communication module 610 and the receptor 670. The receptor 670 may comprise an inductive receptor that may be heated via induction as described herein. The receptor 670 may provide heat for heating the smart accessory 600 and/or contents within, adjacent, or near the smart accessory 600 (e.g., food product, beverage, and/or any other substance within proximity of the smart accessory 600). The receptor 670 may be located inside the smart package accessory 600, coupled to the exterior of the smart accessory 600, and/or have combination of interior and exterior exposure of the smart accessory 600.

The smart accessory 600 may be composed of any material suitable for a particular application. For example, the smart accessory 600 may be composed of material that may be in direct contact with human-consumable matter (e.g., food, beverage, etc.). For example, the smart accessory 600 may comprise plastic, composite, glass, silicone, rubber, cardboard, and/or any other material (e.g., that may be used to contain and/or package a food product and/or a beverage product). The smart accessory 600 may comprise material that may be non-metal and/or substantially non-metal. For example, the smart accessory 600 may comprise a non-metal material coating that may cover the communication module 610 and/or the receptor 670. The communication module 610 and/or the receptor 670 may comprise metal material. The smart accessory 600 may be placed inside, underneath, adjacent, and/or on a container, holder, and/or any other apparatus or package to heat the associated contents therein. The smart accessory 600 may be a standalone and/or reusable (e.g., washable) apparatus. The smart accessory 600 may be in the form of a container (e.g., a mug, a cup, a bowl, etc.), that may be used for heating contents therein (e.g., coffee, hot chocolate, soup, pasta, and/or any food and/or beverage). Additionally or alternatively, the smart accessory 600 may be integrated into a disposable and/or recyclable package (e.g., a container for soup, pasta, meat products, ready-to-cook/all-in-one meals, and/or any other food product and/or beverage), for example, wherein a side of the package may comprise the communication module 610 (e.g., an RFID tag) and a bottom of the package (or another side substantially perpendicular to the side of the package comprising the communication module 610) may comprise the receptor 670.

The smart accessory 600 may comprise one or more tabs. The smart accessory 600 may comprise tab 602 that may operate as a pull tab. The smart accessory 600 may comprise one or more pull tabs at any location, and/or the tab 602 may be located at any portion of the smart accessory 600. The tab 602 may allow for removal of the smart accessory 600 from a container, holder, and/or any other apparatus with which the smart accessory 600 may be used. The smart accessory 600 may comprise a tab 604 that may operate as an insertion tab. The smart accessory 600 may comprise one or more insertion tabs at any location, and/or the tab 604 may be located at any portion of the smart accessory 600. The one or more tabs (e.g., 602, 604) may hold the smart accessory 600 in place within a container in which the smart accessory 600 may be used. The one or more tabs (e.g., 602, 604) may be composed of a flexible material (e.g., silicone, plastic, rubber, and/or any other material or combination thereof). The one or more tabs (e.g., 602, 604) may form and/or press to the shape of a container in which the smart accessory 600 may be used. The one or more tabs (e.g., 602, 604) may hold the smart package accessory 600 in place, for example, in a mug in which the smart accessory 600 may be used to heat liquid (e.g., water, coffee, hot chocolate, and/or any other liquid). The one or more tabs (e.g., 602, 604) may hold the smart package accessory 600 in place (e.g., in a mug, a cup, etc.), during and/or after heating such that a user may consume a heated substance (e.g., coffee, water, food, etc.) while the smart accessory remains in place within the container containing the substance.

The placement of the communication module 610 relative to the receptor 670 may reduce RF coupling. The RF coupling between the communication module 610 and the receptor 670 may be reduced, for example, based on a decoupled orientation of the communication module 610 and the receptor 670 (e.g., perpendicular, substantially perpendicular, and/or within a threshold angle such as between 80-100 degrees, 75-105 degrees, 60-120 degrees, or any other angle(s)). The receptor 670 may shunt RF signals and/or electromagnetic energy (e.g., from the base station 200 or any other device) from the communication module 610, for example, based on a decoupled orientation of the communication module 610 and the receptor 670. The communication module 610 may be protected from thermal energy (e.g., from the receptor 670), for example, based on a decoupled orientation of the communication module 610 and the receptor 670. For example, the heating field may be decoupled with the RF communication field, which may provide advantages such as reduced interference of the heating field on the RF communication field, which may improve communications (e.g., increase the likelihood of successful communications).

FIG. 6B shows an example of a smart accessory within a container. A smart accessory 600 may be placed within, inside, under, and/or on top of a container and/or any other apparatus. For example the smart accessory 600 may be designed for placement into a mug, cup, container (e.g., container 650), holder, and/or any other apparatus to heat contents therein. The smart accessory 600 may comprise part of the container 650 itself. For example, the smart accessory 600 may be built into the base and/or sidewall of a mug, such that the smart accessory 600 may not be visible, may not be exposed, and/or may not be removable. The smart accessory 600 may heat the contents (e.g., food, liquid, and/or any substance therein) of the container 650, for example, based on heating of the receptor 670 (e.g., via the base station 200 and/or via any other device). One or more tabs (e.g., tab 604) may hold the smart accessory 600 in place in the container 650, for example, based on the tab 604 being in contact with the sidewall of the container 650. The smart accessory 600 may be removable from the container 650 (e.g., by a user at the conclusion of heating and/or at the conclusion of consumption of heated contents). One or more tabs (e.g., tab 602) may be used as a pull tab to remove the smart accessory 600 from the container 650. The communication module 610 within the smart accessory 600 may be used (e.g., controlled by the base station 200 and/or any other device) to determine whether the container 650 contains one or more substances for heating (e.g., food, liquid, etc.).

A base station (e.g., base station 200) may determine if the container 650 contains one or more substances for heating (e.g., food, liquid, etc.), for example, based on the smart accessory 600. The base station 200 may measure one or more temperatures in or near the smart accessory 600 (e.g., the temperature at the receptor 670, the ambient temperature at the smart accessory 600). The base station 200 may determine that the container 650 does not contain contains one or more substances for heating, for example, based on a differential of the one or more temperatures in or near the smart accessory 600. For example, a differential between a temperature at the receptor 670 and a temperature at the communication module 610 may indicate material (e.g., liquid) is present, or is not present, in the container 650. The base station 200 may determine that the container 650 does contain material, for example, based on a similarity of the one or more temperatures at the smart package accessory 600. For example, a similarity between a temperature at the receptor 670 and a temperature at the communication module 610 may indicate material (e.g., liquid) is present in the container 650. Heating of the material by the receptor 670 may cause corresponding heating of the communication module 610, which may be used to determine a temperature differential (and/or the presence or absence of material within the container for heating).

The base station 200 (or any other device) may determine an amount of material a container. The base station 200 (or any other device) may determine an amount of material (e.g., liquid) within the container 650, for example, if the container 650 includes the smart accessory 600 in the container 650. One or more temperature sensor(s) in the communication module 610 may measure a temperature change in the material contained in the container 650. The base station 200 may determine the amount of material in the container 650, for example, based on a comparison of the measured temperature change, the amount of power delivered by the base station 200, and the specific heat of the material container in the container 650. For example, if the container 650 is full of liquid, and if the smart accessory 600 is included in the container 650, the base station 200 may expect an application of a fixed amount of power applied near the receptor 670 to yield a proportional relatively low temperature differential between a temperature measurement in the communication module 610 and a temperature measurement in or near the receptor 670. As another example, if the container 650 has no liquid, and if the smart accessory 600 is included in the container 650, the base station 200 may expect an application of a fixed amount of power applied near the receptor 670 to yield a proportional relatively high temperature differential between a temperature measurement in the communication module 610 (e.g., low similar proportional to ambient temperature) and a temperature measurement in or near the receptor 670 (e.g., higher temperature due to application of power near the receptor 670). Similarly, the base station 200 may determine the amount of material in the container 650, based on measurement of temperatures at temperature sensors of the smart package accessory 600 that are located at known volumetric increments within the container 650.

FIG. 7A shows an example of a concentrator. A concentrator 730 may comprise one or more characteristics of a receptor, such as any of the receptors described herein (e.g., receptor 170, inductive receptor 302, inductive receptor 306, inductive receptor 310, inductive receptor 314, inductive receptor 402, receptor 670). The concentrator 730 may be generally referred to as a heat concentrator. Additionally or alternatively, the concentrator 730 may be used in place of or in addition to any of the receptors described herein. For example, the concentrator 730 may be used with the smart accessory 600 (e.g., in addition to or in place of the receptor 670). The concentrator 730 may be heated via induction to heat an object (e.g., a container, can, mug, package, and/or any other object that may comprise food and/or liquid). The concentrator 730 may be composed of a conductive and/or flexible material, such as a metal (e.g., low-resistance ferromagnetic steel). The concentrator 730 may comprise a first end (e.g., end 731) and a second end (e.g., end 732). The concentrator 730 may be flexible to accommodate being bent and/or curved, such as to form a circle or oval shape. Additionally or alternatively, the concentrator 730 may be generally rigid/inflexible and/or manufactured to be formed in a circular or oval-shaped. The concentrator 730 may be wrapped, curved, and/or shaped such that a first end (e.g., end 731) and a second end (e.g., end 732) of the concentrator 730 may be in contact to form a closed loop. The concentrator 730 may comprise one or more cutouts, such as a first cutout 751 and a second cutout 752. The first cutout 751 may be shaped to attach and/or secure to a portion of the second end 732, for example, if the concentrator is wrapped, curved, and/or shaped in a circular or oval shape. The second cutout 752 may be shaped to attach and/or secure to a portion of the first end 731, for example, if the concentrator 730 is wrapped, curved, and/or shaped in a circular or oval shape. The concentrator 730 may comprise one or more tabs 740. The one or more tabs 740 may guide placement of an object (e.g., a can and/or any other object containing liquid and/or food) within the concentrator 703 (e.g., such that the one or more tabs 740 may frictionally engage an outer surface of the object). Additionally or alternatively, the one or more tabs 740 may guide placement of the concentrator 730 within an object (e.g., within a liquid containing portion of a mug and/or cup, such that the one or more tabs 740 may frictionally engage an inner surface of the object).

FIG. 7B shows an example of a smart apparatus in combination with a concentrator and a container. A smart apparatus 700 may comprise a base 710 and/or the concentrator 730 (e.g., as described with respect to FIG. 7A). The concentrator 730 may be included within the base 710, attached (e.g., removably attached) to the base 710, and/or separate from the base 710 (e.g., configured for placement between the base 710 and a container 750). The base 710 may comprise a communication module 720. The communication module 720 may comprise any communication module and/or tag (e.g., RFID tag) described herein (e.g., communication module 106, communication tag 400, package/tag 500, and/or communication module 610) and/or any portion or combination thereof. The base 710 may be composed of any material, such as plastic, composite, glass, silicone, and/or any other material (e.g., any non-metal material). The base 710 may be any shape, such as a cylinder (e.g., as shown in FIG. 7B as a cross-section view), a cube, and/or any other shape comprising any straight and/or curved portion(s). The concentrator 730 may be formed and/or inserted to line the inner sidewalls of the base 710 (e.g., as shown in FIG. 7B). The concentrator 730 may line the inner sidewalls of the base 710, for example, such that a container (e.g., container 750) may be placed near and/or in contact with the concentrator 730 (e.g., for induction heating). The communication module 720 may perform various operations. The communication module 720 may perform one or more of the operations of any communication module and/or tag (e.g., RFID tag) described herein (e.g., communication module 106, communication tag 400, package/tag 500, and/or communication module 610) and/or any portion or combination thereof. The operations may comprise, for example, wireless communications and/or wired communications. The communication module 720 may enable heating of the smart apparatus 700 (e.g., via an induction heating device). While the container 750 may comprise any type of container for holding food and/or liquid, the container may additionally or alternatively comprise any substance for heating. For example, the container 750 may comprise wax, a candle (e.g., a wickless candle or a candle comprising a wick), and/or the like (or any of the above within an object such as a glass container, a ceramic object, etc.), wherein the base 710 and/or the concentrator 730 may be used to heat the substance (e.g., wax, such as scented or unscented wax) for atmospheric effect, scent, and/or heating effect. Additionally or alternatively, an apparatus comprising the base 710 and/or the concentrator 730 may be filled with any quantity of any substance (e.g., soup, wax, and/or the like) without (e.g., in place of) the container 750 such that the base 710 and/or the concentrator 730 heat the substance within the base rather than heating an object such as the container 750. Additionally or alternatively, the base 710 may comprise the concentrator 730 (and/or any other concentrator) internal to the base (e.g., fully enclosed, such as in a silicone vessel), which may be washable (e.g., dishwasher safe), reusable, etc.

The placement of the communication module 720 relative to the concentrator 730 may reduce RF coupling. The RF coupling between the communication module 720 and the concentrator 730 may be reduced, for example, based on a decoupled orientation of the communication module 720 and the concentrator 730 (e.g., perpendicular, substantially perpendicular, and/or within a threshold angle such as between 80-100 degrees, 75-105 degrees, 60-120 degrees, or any other angle(s)). The concentrator 730 may shunt RF signals and/or electromagnetic energy (e.g., from the base station 200 or any other device) from the communication module 720, for example, based on a decoupled orientation of the communication module 720 and the concentrator 730. The communication module 720 may be protected from thermal energy (e.g., from the concentrator 730), for example, based on a decoupled orientation of the communication module 720 and the concentrator 730.

The smart apparatus 700 may be used to heat a container (e.g., container 750). The smart apparatus 700 may heat the container 750, for example, based on the package being placed near and/or in contact with the concentrator 730. The concentrator 730 may concentrate an induction field within the area of the concentrator 730. A thickness of the concentrator 730 may be proportional to a thickness of the container 750. For example, the thickness of the concentrator 730 may be comprise a multiple of a range of thicknesses, such as 0.5 to 4 times (or any other multiplier), relative to the thickness of the container 750. The thickness of the concentrator may comprise between 0.5 times-4 times the thickness of the package 750, for example, to concentrate an induction field and induce a current in the package 750. For example, a relatively thin container (e.g., a thin aluminum beverage can) may be heated using a concentrator 730 that is relatively thin, whereas a relatively thick container (e.g., a thick soup can) may be heated using a concentrator 730 that is relatively thick. The concentrator 730 may be removable from the base 710, for example, to allow a user to insert a different concentrator (e.g., having a different thickness and/or a different material composition) within the base 710 for heating a different container. One or more concentrators may be provided for a corresponding one or more types of heating operations (e.g., cooking, reheating, warming, etc.) and/or one or more types of containers (e.g., different types of thicknesses, materials, and/or contents). Additionally or alternatively, one or more concentrators may be added to a base (e.g., which may comprise an initial concentrator) for one or more types of heating operations, and/or one or more types of containers, that may require additional heating relative to heating that may be provided by an initial concentrator. An induction field (e.g., from an induction heating device such at the base station 200 and/or any other device) may induce a current in the concentrator 730. The induced current in the concentrator 730 may induce a current in the container 750. An induced current in the concentrator 730 may induce a current in the container 750, for example, if the container 750 is composed of metal (e.g., a metal can). An induced current in the container 750 may cause heating of the container 750 and the contents therein. The induction heating of the concentrator 730 may heat the container 750 via contact with the concentrator 730 and/or via an induced current in the container 750, for example, for a container 750 placed in contact with the concentrator 730. The concentrator 730 may be used to heat liquid and/or any other substance contained in the container 750 (e.g., a can).

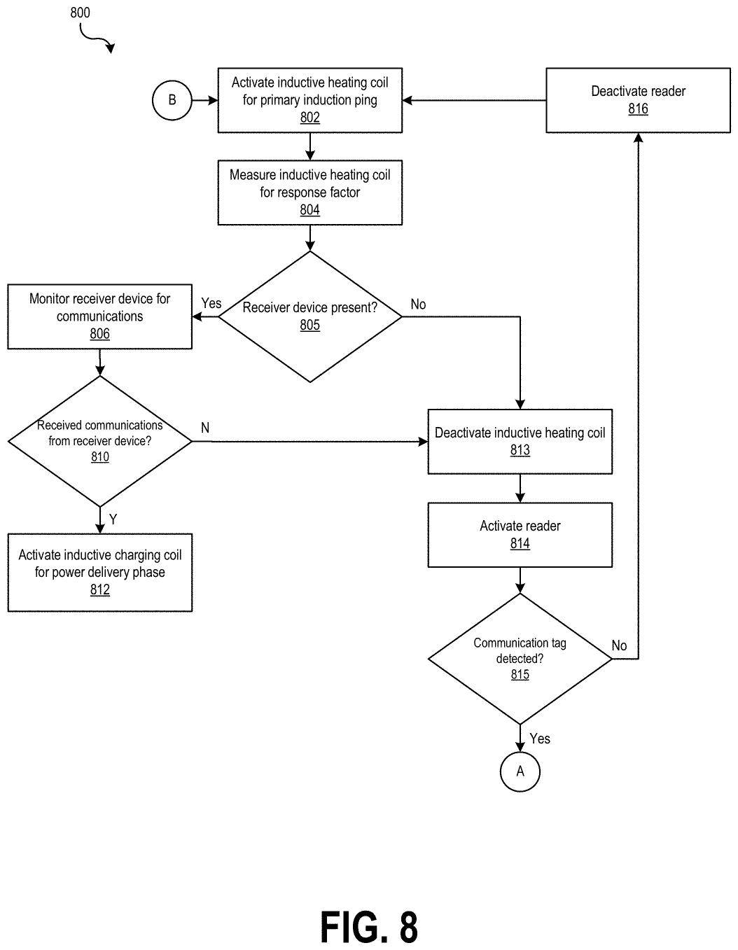

FIG. 8 shows an example of a method for detection of a smart package, a smart accessory, and/or a smart apparatus. The method for detection may comprise a process 800 that may be used, for example, to determine a presence of (and/or identify) an induction receiver device (e.g., the smart package 100, the smart package assembly 5000, the smart accessory 600, the smart apparatus 700, a wireless device such as a smart phone, and/or any other device that may be inductively heated and/or inductively charged) and/or a communication module (e.g., a communication tag and/or any communication module described herein or a component thereof). The process 800 may be performed, for example, to identify an induction receiver device when placed on top of an induction base such as a base station (e.g., the base station 200). The process 800 may be performed, for example, prior to a process of heating the induction receiver device and/or heating contents of the induction receiver device and/or an associated container (e.g., contents of the smart package 100, contents of the container 650, and/or contends of the container 750). At step 802, a base station (e.g., the base station 200 and/or any other device) may activate one or more inductive heating coils (e.g., the inductive heating coil 242) for a primary induction ping. The inductive heating coil(s) may be activated in a low energy state for the primary induction ping. The low energy state may comprise, for example, a first frequency (and/or a first range of frequencies) and/or a first power (and/or a first range of powers). At step, 804, the base station may perform measurements at the one or more inductive heating coils for one or more response factors. The one or more response factors may comprise, for example, a change in power delivered by the inductive heating coil(s) and/or a change in impedance of the inductive heating coil(s). Measuring for one or more of the response factors may indicate the presence of the induction receiver device within a proximity of the inductive heating coil 242 (and the associated base station). The proximity may comprise a threshold distance within a range of locations and/or approximately in a position such that the induction receiver device rests on top of the base station. The proximity may vary, for example, based on one or more of: an operation (e.g., inductive heating and/or inductive charging), a device type (e.g., inductive heating device to be used for heating and/or wireless device to be charged), materials of a device, a location of a communication module within a device, a signal transmission quality (e.g., power, signal strength, interference) such as for a wireless transmission, and/or any condition. The induction receiver device may be a device capable of receiving induction power. At step 805, the base station may determine whether an induction receiver device is present at the base station and/or has not been identified, for example, based on measuring for the one or more response factors.

At step 813, the base station may deactivate the inductive heating coil(s). The base station may deactivate the inductive heating coil(s), for example, based on a determination that an induction receiver device is not present and/or has not been identified (e.g., at step 805). At step 806, the base station may monitor for one or more communications from the induction receiving device. The base station may monitor for one or more communications from the induction receiving device, for example, if the base station determines that an induction receiver device is present and/or if the base station identifies the induction receiver device (e.g., at step 805). The one or more communications may comprise in-band communication (e.g., as modulated impedance of the power delivery from the base station (e.g., according to a Qi-enabled device)) and/or out-of-band communication (e.g., Bluetooth and/or any other communication protocol). For example, the activated inductive heating coil(s) (e.g., from step 802) may provide power to an electronic receiver (e.g., harvesting module 116 and/or any other receiver) of an induction receiver device. Based on receiving power from the base station, the induction receiving device may send one or more communications (e.g., via the antenna 110 and/or any other antenna) to the base station. The one or more communications may identify the induction receiving device (e.g., as a wireless charging device, a smart package 100, a smart package assembly 5000, a smart accessory 600, a smart apparatus 700, and/or any other device). The one or more communications may comprise an identifier (e.g., a unique identifier) that may be associated with the inductive receiving device. The one or more communications may comprise one or more instructions for providing power to the induction receiver device. The one or more instructions for providing power to the induction receiver device may comprise feedback information from the induction receiver device. The feedback information may comprise, for example, one or more of a: measurement value (e.g., temperature), time and/or duration, operation (e.g., heating and/or charging), status (e.g., active, inactive), failure event (e.g., overheating, failure to charge, etc.), and/or any other information.

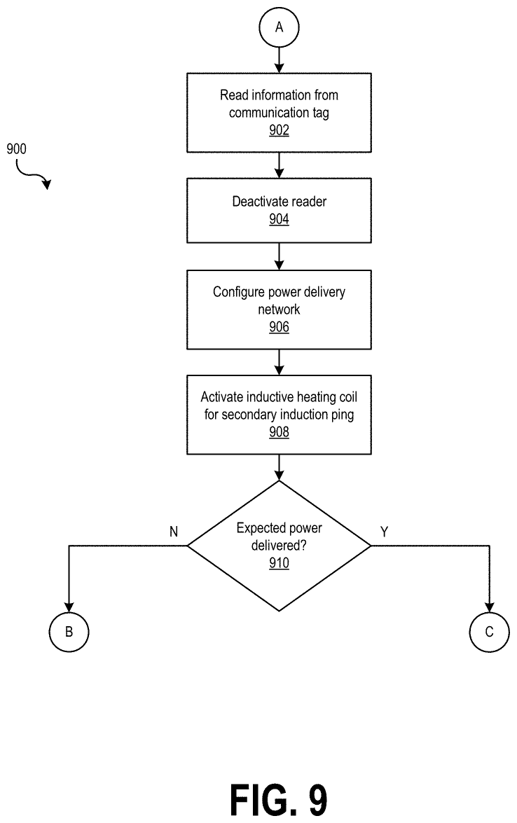

At step 810, the base station may determine whether one or more communications from the induction receiver device were received. At step 812, the base station may activate an induction power delivery phase (e.g., for wireless charging). The base station may activate an induction power delivery phase (e.g., for wireless charging), for example, based on a determination that the one or more communications from the induction receiver device were received. Activating the induction power delivery phase may comprise the base station activating one or more inductive charging coil(s). The base station may activate the induction power delivery phase according to the one or more received communications. At step 813, the base station may deactivate the inductive heating coil(s). The base station may deactivate the inductive heating coil(s), for example, based on a determination that one or more communications were not received from the induction receiver device. At step 814, the base station may activate a reader (e.g., such as the reader 210, an NFC reader, and/or any other reader) to determine (e.g., read and/or identify) the presence of one or more communication tags (e.g., antenna 110 and/or any other antenna). The induction receiver device (e.g., the smart package 100, the smart package assembly 5000, the smart accessory 600, the smart apparatus 700, and/or any induction receive device described herein) may comprise a communication tag (e.g., antenna 110). At step 815, the base station may determine whether a communication tag (e.g., antenna 110) is detected by the reader, for example, based on activating the reader to determine the presence of one or more communication tags (e.g., antenna 110). At step 816, the base station may deactivate the reader. The base station may deactivate the reader, for example, if a communication tag (e.g., antenna 110) is not detected by the reader. The base station may proceed to step 802 as described herein. The base station 200 may proceed to 802, for example, based on deactivating the reader. The process 800 may advance to step 902 of a process 900 described herein with respect to FIG. 9 (e.g., as shown by indicator “A”). The process 800 may advance to 902 of the process 900, for example, if a communication tag (e.g., antenna 110) is detected by the reader.

FIG. 9 shows an example of a method for detection and/or heating. The heating operation may comprise a process 900 for heating contents of a smart package (e.g., the smart package 100) and/or contents of a container (e.g., the container 650, the container 750, and/or any other container) associated with a smart package/tag (e.g., the smart package assembly 5000), a smart accessory (e.g., the smart accessory 600) and/or a smart apparatus (e.g., the smart apparatus 700). At step 902, a reader (e.g., such as the reader 210 and/or any other reader) of a base station (e.g., the base station 200 and/or any other base station) may determine (e.g., read and/or identify) information (e.g., induction ping parameters, a heating profile, and/or any other information) from a communication tag (e.g., antenna 110). The reader of the base station may read information (e.g., induction ping parameters, a heating profile, and/or any other information) from the communication tag (e.g., antenna 110), for example, if the base station identifies a communication tag (e.g., antenna 110) at step 815 as described herein with respect to FIG. 8. The information may comprise heating instructions for one or more of: a frequency, power, and/or time duration. The heating instructions may be used to inductively heat a receptor (e.g., the receptor 170, the inductive receptor 302, the inductive receptor 306, the inductive receptor 310, the inductive receptor 314, the inductive receptor 402, and/or any other receptor and/or concentrator described herein). The information may comprise material descriptors for the receptor. The base station may determine (e.g., identify) an expected frequency and/or an expected power range(s) for one or more inductive heating coils (e.g., the inductive heating coil(s) 242), for example, if the receptor is in close proximity. At step 904, the base station may deactivate the reader. The base station may deactivate the reader, for example, based on reading information from the communication tag. At step 706, the base station may configure power delivery (e.g., a power delivery network) for the inductive heating coil(s). The base station may configure the power delivery network for the inductive heating coil, for example, based on deactivating the reader 210. To configure power delivery for the inductive heating coil(s), the base station may configure a bridge configuration (e.g., half-bridge, full-bridge, and the like), a resonant network, a power supply (e.g., the power supply 246), a high voltage driver (e.g., the high voltage driver 247), and/or drive frequencies for the inductive heating coil(s) (e.g., the inductive coil(s) 242). For example, one or more inductive coils (e.g., inductive heating coil(s) 242, inductive charging coil(s) 244) of the base station may be nominally resonant at a first frequency (e.g., 100 kHz and/or any other frequency). The inductive coil(s) may deliver power, for example, using a half-bridge drive at a second frequency (e.g., 180 kHz and/or any other frequency) for an inductive receiver device configured for a charging system or protocol (e.g., Qi and/or any other inductive charging system or protocol). The base station may configure the resonant network to a third frequency (e.g., 50 kHz and/or any other frequency), for example, using a full-bridge drive at a fourth frequency (e.g., 85 kHz and/or any other frequency) based on communicating with an inductive receiver device configured for a second system (e.g., NFC).

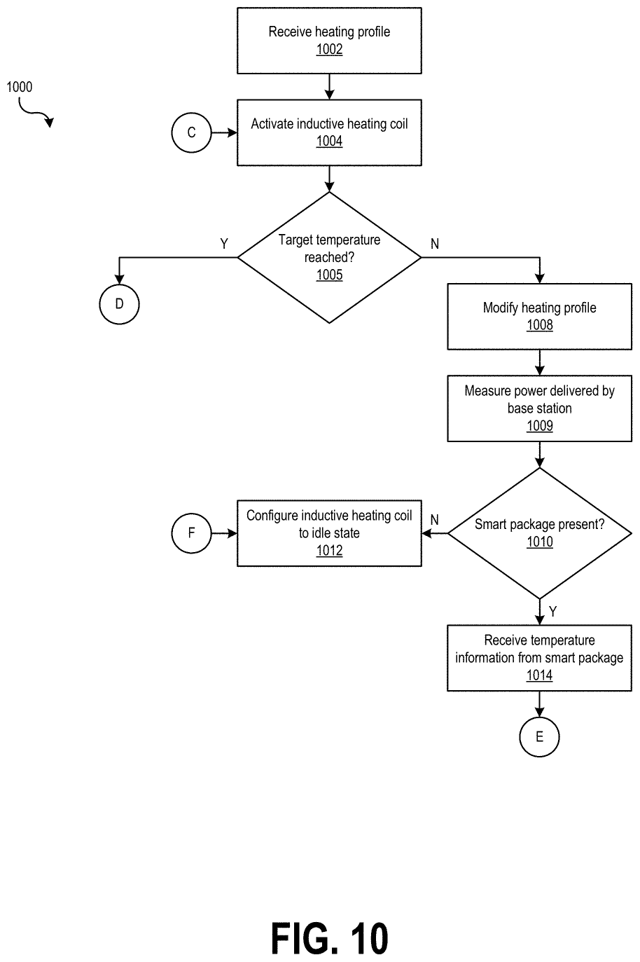

At step 908, the base station may activate the inductive heating coil(s) for a secondary induction ping. The base station may activate the inductive heating coil(s) for a secondary induction ping, for example, based on configuring a power delivery network for the inductive heating coil(s). At step 910, the base station may determine whether the power delivered by the inductive heating coil(s) satisfies (e.g., is within a threshold range of) an expected power. The base station may determine whether the power delivered by the inductive heating coil(s) satisfies an expected power, for example, based on activating the inductive heating coil(s) for a secondary induction ping. If the expected power delivered by the inductive heating coil 242 is not satisfied (e.g., is not within a threshold range of an expected power, such as within 1%, 2%, 5%, 10%, or any other value or tolerance), the base station may determine that a receptor is not present at the base station, and/or the process 900 may proceed to 802 as described herein with respect to FIG. 8 (e.g., as shown by indicator “B”). If the power delivered by the inductive heating coil(s) satisfies (e.g., is within a threshold range of an expected power, such as within 1%, 2%, 5%, 10%, or any other value or tolerance) an expected power, the base station may determine that a receptor is present at the base station, and/or the process 900 may proceed to step 1004 as described herein with respect to FIG. 10 (e.g., as shown by indicator “C”).

FIG. 10 shows an example of a method for heating. A heating operation 1000 may comprise heating contents of a smart package (e.g., the smart package 100) and/or contents of a container (e.g., the container 650, the container 750, and/or any other container) associated with a smart package/tag (e.g., the smart package assembly 5000), a smart accessory (e.g., the smart accessory 600) and/or a smart apparatus (e.g., the smart apparatus 700). At step 1002, a base station (e.g., the base station 200 and/or any other base station) may receive a heating profile for a smart package and/or a heating profile associated with a smart accessory or a smart apparatus. The base station may receive the heating profile, for example, by reading (e.g., via the reader 210) a communication tag (e.g., antenna 110) of the smart package, the smart accessory, and/or the smart apparatus. The base station may receive the heating profile via a storage device (e.g., a cloud database, a local database, a remote database, and/or any other storage device) that may be accessed via a network (e.g., the WAN 10, a local area network, and/or any other network). The base station may receive the heating profile via one or more user inputs at the base station and/or at a user device (e.g., a smartphone and/or any wireless device) that may be connected to and/or in communication with the base station (e.g., via the WAN 10 a local area network, and/or any other network). The heating profile may comprise one or more heating preferences and/or parameters. A heating preference and/or parameter may comprise one or more of: a target power (e.g., power applied to the smart package 100 via the inductive heating coil 242, the power generated by the inductive heating coil 242, etc.), a target temperature (e.g., the target temperature of the smart package 100 and/or the contents of the smart package 100), a heating time (e.g., the duration and/or time to heat the smart package 100), and/or an operational boundary for the base station (e.g., maximum frequency of operation for the inductive heating coil 242, minimum frequency of operation for the inductive heating coil 242, etc.). At step 1004, the base station may activate one or more inductive heating coils (e.g., the inductive heating coil(s) 242). The base station may activate the inductive heating coil(s), for example, based on receiving the heating profile. The base station may activate the inductive heating coil(s), according to the heating profile, to heat via a receptor: a smart package, a smart accessory, a smart apparatus, contents therein, and/or contents in an associated container. For example, the base station may heat the smart package 100 via the receptor 170.

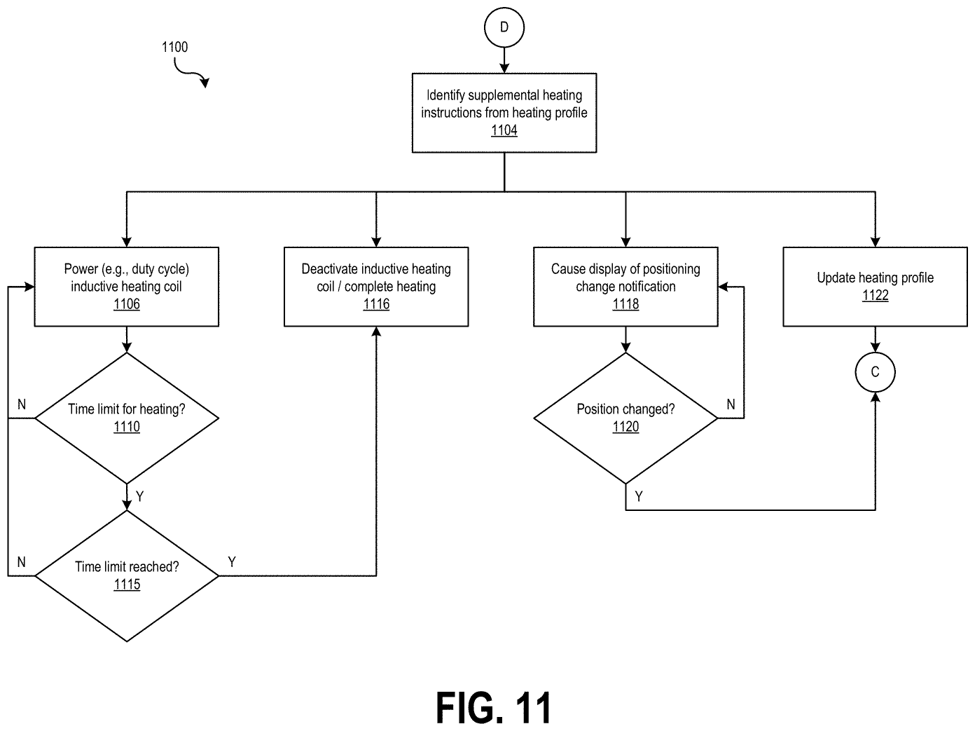

At step 1005, the base station may determine whether a target temperature has been reached. The target temperature may comprise a target temperature of one or more of: the smart package 100, contents of the smart package 100, and/or contents of a container (e.g., the container 650, the container 750, and/or any other container) associated with a smart package/tag (e.g., the smart package assembly 5000), a smart accessory (e.g., the smart accessory 600) and/or a smart apparatus (e.g., the smart apparatus 700). The base station may determine whether the target temperature has been reached, for example, based on activating the inductive heating coil(s). The base station may monitor a communication tag (e.g., antenna 110) of a smart package, a smart accessory, and/or a smart apparatus for one or more communications (e.g., NFC communications), for example, to determine whether the target temperature has been reached. If the base station determines that the target temperature has been reached, the process may continue at step 1104 as described herein with respect to FIG. 11 (e.g., as shown by indicator “D”). At step 1008, the base station may modify a heating profile of the inductive heating coil(s), for example, if the base station determines that the target temperature has not been reached. The base station may modify the heating profile, for example, to optimize power delivery to the smart package 100, the smart accessory 600, and/or the smart apparatus 700. The base station may modify the heating profile to target the configured temperature for one or more of: a receptor (e.g., the inductive receptor 170), the smart package 100, contents of the smart package 100, and/or contents of a container (e.g., the container 650, the container 750, and/or any other container) associated with a smart accessory (e.g., the smart accessory 600) and/or a smart apparatus (e.g., the smart apparatus 700). The base station may modify the heating profile to adjust the inductive heating coil(s) to a maximum allowable power, for example, if the maximum allowable power of the inductive heating coil(s) is less than the maximum configured power to heat the smart package 100, contents of the smart package 100, and/or contents of a container (e.g., the container 650, the container 750, and/or any other container) associated with a smart accessory (e.g., the smart accessory 600) and/or a smart apparatus (e.g., the smart apparatus 700). At step 1009, the base station may measure and/or determine power delivered (or to be delivered) by the base station (e.g., via induction coil(s)).

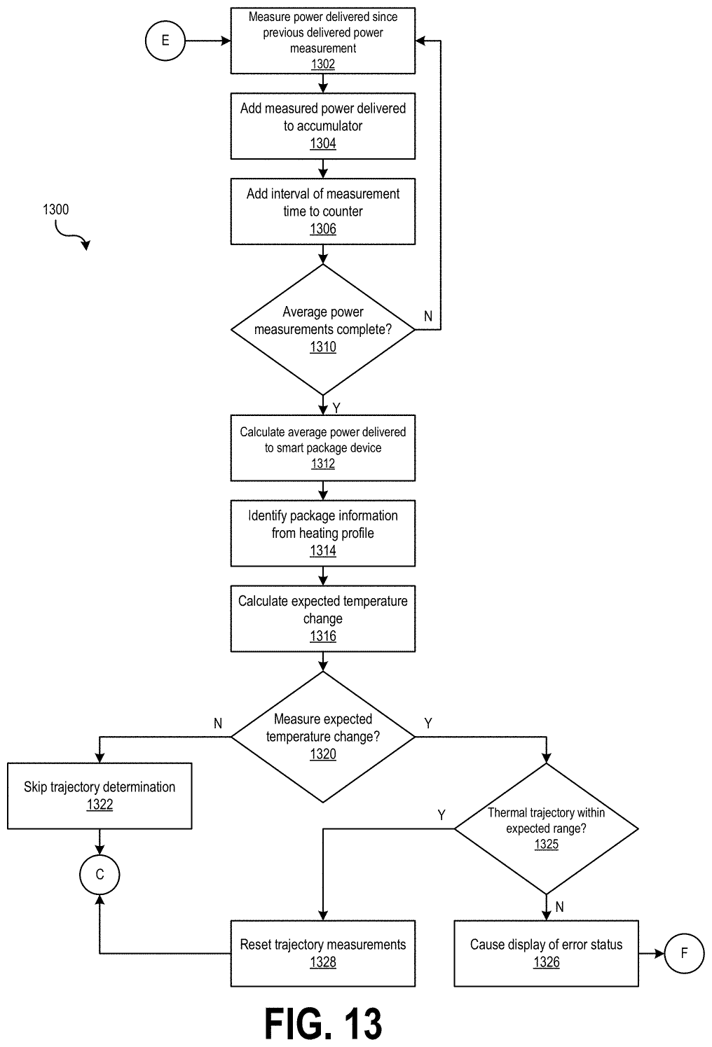

At step 1010, the base station may determine whether a smart package/accessory/apparatus (e.g., the smart package 100, the smart package/tag 5000, the smart accessory 600, and/or the smart apparatus 700) is present. The base station may determine whether the smart package/accessory/apparatus is present, for example, at or near (e.g., within a threshold distance from) induction coil(s) in the base station. The base station may determine whether the smart package/accessory/apparatus is present, for example, based on comparing the measured power delivered by the inductive heating coil(s) with the target requested power to heat the smart package/accessory/apparatus. The heating profile may include the target requested power to heat the smart package/accessory/apparatus. At step 1012, the base station may configure the inductive heating coil(s) to an idle state (e.g., non-heating state, inactive state, and/or power-saving state). The base station may configure the inductive heating coil(s) to an idle state, for example, if the base station determines that the smart package/accessory/apparatus is not present at or near (e.g., within a threshold distance from) the induction coil(s). At step 1014, the base station may receive the temperature information for the smart package/accessory/apparatus. The base station may receive the temperature information for the smart package/accessory/apparatus, for example, if the base station determines that the smart package/accessory/apparatus is present at or near (e.g., within a threshold distance from) the induction coil(s). The base station may receive the temperature information of the smart package/accessory/apparatus, for example, by reading a communication tag (e.g., antenna 110) of the smart package/accessory/apparatus. After step 1014, the process may continue at step 1302 as described herein with respect to FIG. 13 (e.g., as shown by indicator “E”).

FIG. 11 shows an example of a method for heating. A heating operation 1100 may comprise heating contents of a smart package (e.g., the smart package 100) and/or contents of a container (e.g., the container 650, the container 750, and/or any other container) associated with a smart package/tag (e.g., the smart package assembly 5000), a smart accessory (e.g., the smart accessory 600) and/or a smart apparatus (e.g., the smart apparatus 700). At step 1104, a base station (e.g., the base station 200 and/or any other base station) may determine/identify supplemental heating instructions for a smart package/accessory/apparatus (e.g., the smart package 100, the smart accessory 600, and/or the smart apparatus 700). The base station 200 may determine/identify supplemental heating instructions for the smart package/accessory/apparatus, for example, based on reaching a target temperature for the smart package/accessory/apparatus. The supplemental heating instructions may comprise one or more of: instructions to maintain the target temperature at the smart package/accessory/apparatus (e.g., maintain contents therein at a desired/warm temperature for consumption), instructions that deactivate inductive heating coil(s) (e.g., if heating is complete), instructions to cause display of a notification (e.g., via the user interface 250) to indicate change of the position of the smart package/accessory/apparatus (e.g., change of the position of the smart package 100 on the base station 200), and/or instructions to update one or more heating profiles and continue heating the smart package/accessory/apparatus according to the updated heating profile(s). The supplemental heating instructions may be read from a communication tag (e.g., antenna 110) of a smart package/accessory/apparatus (e.g., as part of the heating profile) and/or a storage location such as a database (e.g., a cloud database) that may be accessed via a network (e.g., WAN 10).

At step 1106, the base station may control power (e.g., duty cycle/modulate) applied to inductive heating coil(s). The base station may control power applied to the inductive heating coil(s), for example, based on the base station determining/identifying supplemental heating instructions for the smart package/accessory/apparatus. The base station may control power applied to the inductive heating coil(s), for example, to maintain a temperature at the smart package/accessory/apparatus within a target range (e.g., greater than a first threshold and/or less than a second threshold). The supplemental heating instructions may comprise the target range. At step 1110, the base station may determine whether the supplemental heating instructions comprise a time limit to maintain the target temperature. The base station 200 may determine whether the supplemental heating instructions comprise a time limit to maintain the target temperature, for example, based on the base station controlling power applied to the inductive heating coil(s). If the base station determines that the supplemental heating instructions do not comprise a time limit, the base station may continue apply power to the inductive heating coil(s) as described herein at 1106. At step 1115, the base station 200 may determine whether a time limit (e.g., indicated by the supplemental heating instructions) has been reached and/or exceeded, for example, if the base station determines that the supplemental heating instructions comprise a time limit to maintain the target temperature. At step 1116, the base station may deactivate the inductive heating coil(s) (e.g., to conclude heating of the smart package 100 via the inductive heating coil 242) and/or determine that heating (e.g., of the smart package 100) is complete. The base station may deactivate the inductive heating coil(s) and/or determine that heating is complete, for example, based on a determination that the time limit has been reached and/or exceeded. The base station may indicate that heating (e.g., of the smart package 100) is complete by causing display of a notification (e.g., at the user interface 250) indicating that heating is complete.

At step 1118, the base station may cause display of a notification (e.g., at the user interface 250). The notification may comprise an indication for a change of a position of the smart package/accessory/apparatus (e.g., change of the position of the smart package 100 on the base station 200). The base station 200 may cause display of a notification to change the position of the smart package/accessory/apparatus, for example, based on supplemental heating instructions. For example, the notification may indicate to a user to physically relocate (e.g., for improved heating) and/or remove (e.g., if heating if completed) a smart package/accessory/apparatus and/or an associated container (e.g., the container 650 and/or the container 750). At step 1120, the base station 200 may determine whether the position of the smart package/accessory/apparatus and/or an associated container (e.g., the container 650 and/or the container 750) has changed, for example, based on one or more communications and/or measurements (e.g., using the antenna 110 and/or reader 210), such as described herein with respect to determining a presence of a smart package/accessory/apparatus. The base station may determine whether the position of a smart package/accessory/apparatus and/or an associated container (e.g., the container 650 and/or the container 750) has changed, for example, after or based on causing display of a notification at the user interface 250 with an indication to change the position of the smart package/accessory/apparatus and/or the associated container. The base station may proceed to step 1004 as described herein with respect to FIG. 10 (e.g., as shown by indicator “C”), for example, if the base station determines that the position of the smart package/accessory/apparatus and/or an associated container has changed. If the base station 200 determines the position of the smart package 100 has not changed at 1120, the process 1100 may proceed to step 1118, as described herein. At step 1122, the base station may update one or more heating profiles. The base station may update one or more heating profile, for example, after and/or based on determining/identifying supplemental heating instructions. For example, the base station may heat a smart package/accessory/apparatus and/or an associated container to a first target temperature according to a first heating profile. The base station may determine/identify a second heating profile. The base station may determine/identify a second heating profile, for example, based on the smart package/accessory/apparatus and/or an associated container reaching the first target temperature. The process 1100 may proceed to step 1004 as described herein with respect to FIG. 10 (e.g., as shown by indicator “C”), for example, after and/or based on updating one or more heating profiles. One or more of steps 1106, 1116, 1118, and/or 1122 may be performed at the same time, at substantially the same time, during overlapping time periods, and/or in any order (e.g., before or after any other step).

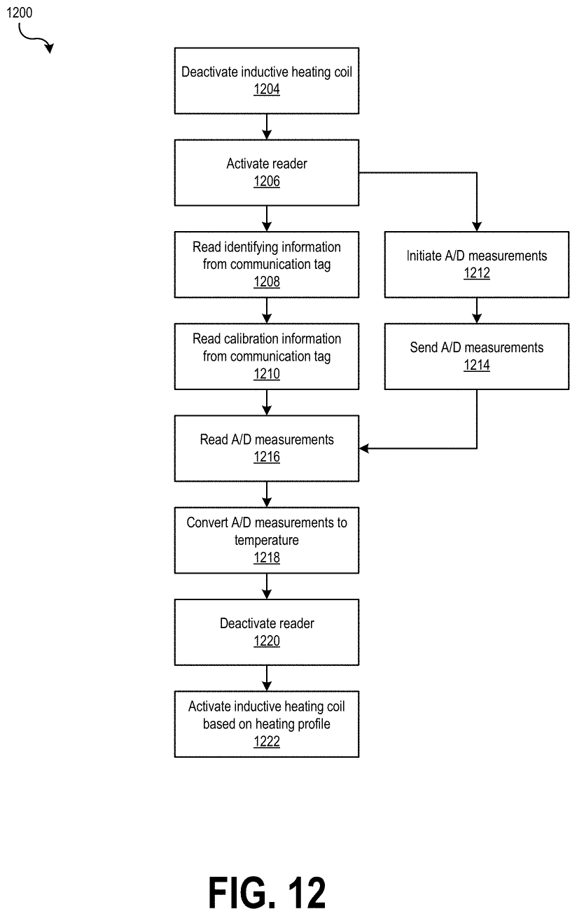

FIG. 12 shows an example of a method for heating. A heating operation 1200 may comprise deactivating heating, activating heating, and/or determining a temperature of a smart package (e.g., the smart package 100), a temperature of contents of a smart package, and/or a temperature of contents of a container (e.g., the container 650, the container 750, and/or any other container) associated with a smart package/tag (e.g., the smart package assembly 5000), a smart accessory (e.g., the smart accessory 600) and/or a smart apparatus (e.g., the smart apparatus 700). At step 1204, a base station (e.g., the base station 200) may deactivate inductive heating coil(s) (e.g., inductive heating coil(s) 242). The base station may deactivate the inductive heating coil(s) to stop heating a smart package, to stop heating contents in a smart package, and/or to stop heating a container (and/or contents therein) associated with a smart accessory and/or a smart apparatus. The inductive heating coil(s) may be deactivated to prevent RF interference between a reader (e.g., the reader 210) and a communication tag (e.g., the antenna 110 of the smart package 100). At step 1206, the base station may activate the reader (e.g. an NFC reader). The base station may activate the reader, for example, based on deactivating the inductive heating coil(s). Activation of the reader may comprise activating the inductive heating coil(s) in a low energy state, for example, which may power a communication tag (e.g., antenna 110 of the smart package 100). At step 1208, the base station may read identifying information from the communication tag (e.g., antenna 110 of the smart package 100). The base station may read identifying information from the communication tag, for example, based on activating the reader. The identifying information may comprise information that identifies a smart package/accessory/apparatus (e.g., the type of smart package/accessory/apparatus, a unique identifier (e.g., serial number) of the smart package/accessory/apparatus, the heating profile for the smart package/accessory/apparatus, and/or any other information associated with the smart package/accessory/apparatus). At step 1210, the base station may read calibration information from the smart package/accessory/apparatus. The base station device may read calibration information from the smart package/accessory/apparatus, for example, based on reading identifying information from the communication tag. The calibration information may comprise information to convert one or more A/D measurements of the smart package/accessory/apparatus (and/or one or more temperature sensors (e.g., 142, 144, and/or 146)) to corresponding temperature measurements.

At step 1212, the base station may initiate A/D measurements and/or communication of the A/D information (e.g., temperature sensor information) from the smart package 100. The base station 200 may initiate communication of the A/D measurements (e.g., temperature sensor information) from the smart package/accessory/apparatus, for example, based on activating the reader. To initiate communication of the A/D measurements between the smart package/accessory/apparatus and the base station, the smart package/accessory/apparatus may generate a message comprising the A/D measurements (e.g., package the A/D information in a message). The smart package/accessory/apparatus may generate the message comprising the A/D measurements, for example, based on the base station deactivating the inductive heating coil(s) and/or based on the base station activating the reader. At step 1214, the smart package/accessory/apparatus may send the A/D measurements (e.g., by sending a message comprising the A/D measurements). The smart package/accessory/apparatus may send the A/D measurements, for example, based on the base station initiating communication of the A/D information (e.g., temperature sensor information) from the smart package/accessory/apparatus. At step 1216, the base station may read the A/D measurements (and/or temperature information, for example, if converted at the smart package/accessory/apparatus) from the communication tag (e.g., antenna 110 of the smart package 100). The base station may read the A/D measurements (and/or temperature information, for example, if converted at the smart package/accessory/apparatus) from the communication tag, for example, based on reading calibration information from the smart package/accessory/apparatus. The base station may read the A/D measurements, for example, based on the smart package/accessory/apparatus sending the A/D measurements. One or more of step 1212 and/or step 1214 may be performed before, during (e.g., in parallel and/or partially or fully overlapping in time with), and/or after one or more of step 1208 and/or step 1210.

At step 1218, the base station may convert the A/D measurements to temperature(s) (e.g., temperature information). The base station 200 may convert the A/D measurements to temperature information, for example, based on reading the A/D measurements (and/or temperature information, for example, if converted at the smart package/accessory/apparatus) from the communication tag of the smart package/accessory/apparatus. The base station may convert the A/D measurements to temperature information, for example, using the calibration information received from the smart package/accessory/apparatus and/or using calibration information that may be stored locally at the base station and/or at any storage device. At step 1220, the base station may deactivate the reader. The base station may deactivate the reader, for example, based on converting the A/D information to temperature information. At step 1222, the base station may activate the inductive heating coil(s) based on (e.g., according to) one or more heating profiles. The base station may activate the inductive heating coil(s), for example, to resume heating of the smart package/accessory/apparatus. The base station may activate the inductive heating coil(s) based on the heating profile, for example, after or based on deactivating the reader.

FIG. 13 shows an example of a method for heating. A heating operation 1300 may comprise identification of a thermal trajectory of a smart package (e.g., the smart package 100), a smart package/tag (e.g., the smart package assembly 5000), a smart accessory (e.g., the smart accessory 600), a smart apparatus (e.g., the smart apparatus 700), and/or contents therein such as contents within a container (e.g., the container 650, the container 750, and/or any other container) associated with a smart accessory and/or a smart apparatus. At step 1302, a base station (e.g., the base station 200) may measure power delivered by inductive heating coil(s) (e.g., the inductive heating coil(s) 242). The base station may measure the power delivered by the inductive heating coil(s), for example, over an interval of time (e.g., during a time period after a previous delivered power measurement). At step 1304, the base station may add the delivered power measurement to an accumulator (e.g., a storage location and/or a value that may be stored at the base station). The base station may add the delivered power measurement to an accumulator, for example, based on measuring the power delivered by the inductive heating coil(s). At step 1306, the base station may increment a counter (e.g., a storage location and/or a value that may be stored at the base station 200) by an interval of time. The base station may increment a counter by an interval of time, for example, based on adding the delivered power measurement to an accumulator. The interval of time may comprise a duration of the delivered power measurement (e.g., such as described with respect to step 1302). The counter may track the number of delivered power measurements for the inductive heating coil(s) and/or the duration of the delivered power measurements for the inductive heating coil(s). The base station may measure the power delivered to the smart package/accessory/apparatus continuously and/or periodically (e.g., each time the base station adjusts the power delivered to the smart package/accessory/apparatus). For example, the base station may adjust the power delivered to the smart package/accessory/apparatus at an interval of 25 ms, 50 ms, 100 ms, or any other duration. The operation 1300 may be executed at an interval of 2.5 seconds, 5 seconds, 10 seconds, or any other duration. At step 1310, the base station may determine whether average power measurements are complete. The base station may determine whether the average power measurements are complete, for example, based on incrementing the counter by an interval of time. The base station may repeat a procedure to measure the power delivered by the inductive heating coil(s) (e.g., such as described with respect to step 1302), for example, if the base station determines that the average power measurements are incomplete. One or more of steps 1302, 1304, 1306, and/or 1310 may be performed any quantity of times (e.g., at least until average power measurements are complete). At step 1312, the base station may determine (e.g., calculate) the average power delivered to the smart package/accessory/apparatus. The base station may determine the average power delivered to the smart package/accessory/apparatus, for example, if the base station determines the average delivered power measurements are complete. To determine the average power delivered to the smart package/accessory/apparatus, the base station may divide the value of the accumulator (e.g., the total delivered power over the interval) by the value of the counter (e.g., the duration the delivered power was measured over the interval).

At step 1314, the base station may determine/identify package information (e.g., for the smart package/accessory/apparatus) based on one or more heating profiles. The base station may determine/identify package information, for example, based on a determination (e.g., calculation) of the average power delivered to the smart package/accessory/apparatus. The package information may comprise an expected volume of the smart package/accessory/apparatus and/or a specific heat of contents of a smart package and/or of a container associated with a smart accessory/apparatus. At step 1316, the base station may determine (e.g., calculate) an expected temperature change at the smart package/accessory/apparatus. The base station may determine the expected temperature change, for example, based on determining/identifying package information (e.g., for the smart package/accessory/apparatus) from the heating profile(s). The expected temperature change may indicate the expected change in temperature at the smart package/accessory/apparatus based on the power delivered to the smart package/accessory/apparatus during a time interval. To calculate the expected temperature change at the smart package/accessory/apparatus, the base station may multiply the average delivered power (e.g., determined from step 1312) by the duration of the average delivered power measurement (e.g., determined from step 1306) to determine the delivered power during the time interval. The base station may divide the power delivered during the interval by the expected volume of the smart package/accessory/apparatus and/or the specific heat of the contents of the smart package/accessory/apparatus, for example, to determine the expected change in temperature at the smart package/accessory/apparatus. The heating profile(s) may not include accurate values for the expected volume and/or the specific heat of the contents of the smart package/accessory/apparatus. For example, if the smart package (and/or a container associated with the accessory/apparatus) contains a variable volume and/or a variable type of liquid, the base station may not be able to accurately determine the expected temperature change. The base station may determine an approximate volume and/or a type of liquid (e.g., most often associated with the particular smart package and/or container) to determine an approximate expected temperature change.

At step 1320, the base station may determine whether the expected change in temperature may be measured accurately (e.g., within a threshold accuracy, such as within 1%, 2% or any other range/tolerance). The base station may determine whether the expected change in temperature may be measured accurately, for example, based on determining (e.g., calculating) the expected temperature change at the smart package/accessory/apparatus. At step 1322, the base station may skip the thermal trajectory determination, for example, if the base station determines that the expected change in temperature cannot be measured accurately (e.g., due to inaccurate values for the expected volume and/or the specific heat of the contents of the smart package and/or container, and/or due to an expected change in temperature being too small such as being below a threshold value). The process 1300 may proceed to step 1004 as described herein with respect to FIG. 10 (e.g., as shown by indicator “C”), for example, after and/or based on skipping the thermal trajectory determination. At step 1325, the base station may determine whether the thermal trajectory for the smart package/accessory/apparatus is within an expected thermal trajectory range, for example, if the base station determines that the expected change in temperature may be measured accurately. The expected thermal trajectory range (e.g., the expected temperature change based on the expected power delivered to the smart package/accessory/apparatus during an interval of time) may be read from the heating profile(s) and/or from a database (e.g., a cloud database) that may be accessed via a network (e.g., WAN 10). At step 1326, the base station may cause display of an error status, for example, if the base station determines that the thermal trajectory range for the smart package/accessory/apparatus is not within the expected thermal trajectory range. The process 1300 may proceed to step 1012 as described herein with respect to FIG. 10 (e.g., as shown by indicator “F”), for example, after and/or based on causing display of an error status. The error status may be displayed via a user interface (e.g., the user interface 250) at a display device of the base station and/or via a display device of a user device (e.g., a mobile phone device) that may be connected to and/or in communication with the base station, such as via a network (e.g., WAN 10). At step 1328, the base station may reset the thermal trajectory measurements (e.g., the expected temperature change, the average delivered power, the accumulator, and/or the counter). The base station may reset the thermal trajectory measurements, for example, if the base station determines that the thermal trajectory range for the smart package/accessory/apparatus is within the expected thermal trajectory range. The process 1300 may proceed to step 1004 as described herein with respect to FIG. 10 (e.g., as shown by indicator “C”), for example, after and/or based on resetting the thermal trajectory measurements.

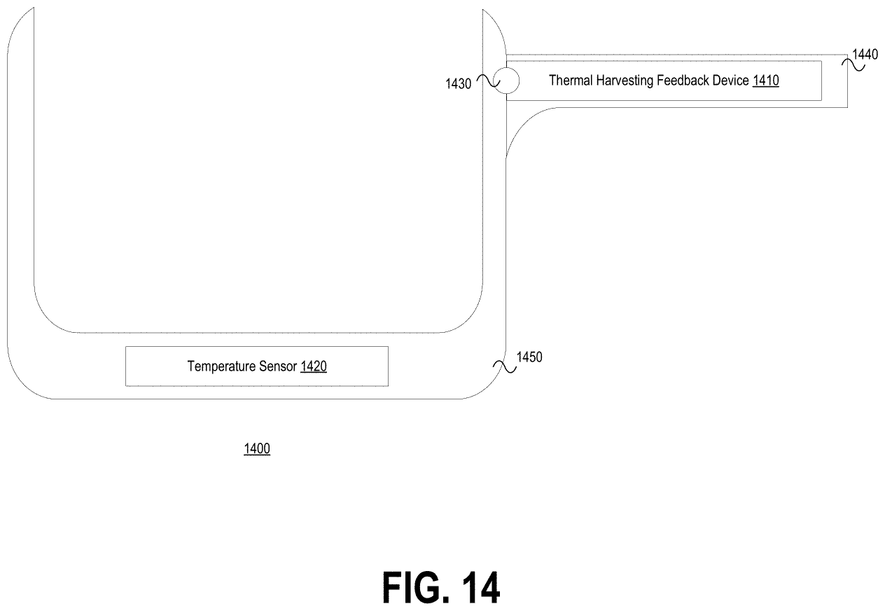

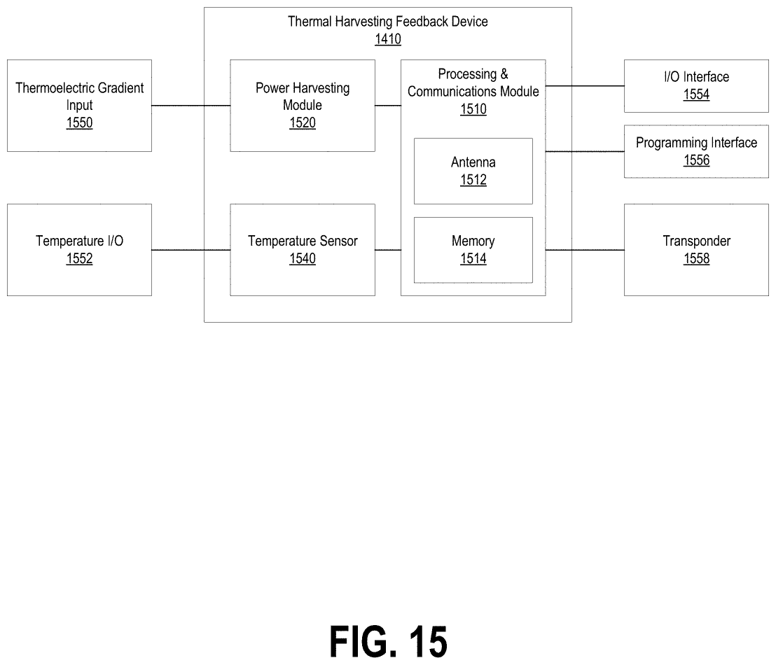

FIG. 14 shows an example of an apparatus and/or a system comprising thermal harvesting feedback. A vessel 1400 may comprise a thermal harvesting feedback device 1410 and one or more temperature sensors 1420. The vessel 1400 may optionally comprise a temperature sensor at, near, and/or connected to a point of connection 1430 (e.g., a screw, seal, lug, etc.) between a handle 1440 and a heating area portion 1450. The temperature sensor at/near/connected to the point of connection 1430 may comprise half of a Peltier device. The vessel 1400 may comprise a vessel configured to be exposed to a thermal energy source (e.g., for heating, cooling, cooking, etc.). The vessel 1410 may comprise a pot, a pan, a package, a container, and/or any other vessel that may be exposed to a thermal energy source (e.g., at the heating area 1450). A thermal gradient (e.g., a difference in temperature) may develop within the vessel 1400 (e.g., a Peltier effect). A thermal gradient may develop within the vessel 1400, for example, if the vessel 1400 is exposed to a thermal energy source. For example, the vessel 1400 (e.g., a pot) may be exposed to a thermal energy source (e.g., an induction cooktop) to heat the vessel 1400 (e.g., at the heating area portion 1450). A thermal gradient may develop between a base of the vessel 1400 (e.g., at a heating area 1450 such as the bottom of a pot and/or pan) and the handle 1440 (e.g., the handle of a pot and/or pan). The handle 1440 of the vessel 1400 may comprise the thermal harvesting feedback device 1410. The thermal harvesting feedback device 1410 may harvest energy (e.g., power). The thermal harvesting feedback device 1410 may harvest energy, for example, based on the thermal gradient developed within the vessel 1400. The thermal harvesting feedback device 1410 may comprise one or more components, such as described herein with respect to FIG. 15. The thermal harvesting feedback device 1410 may use the harvested energy to power the one or more components (and/or any other components requiring power). The thermal harvesting feedback device 1410 may be externally and/or internally coupled to the vessel 1400. For example, the thermal harvesting feedback device 1410 may located on the exterior of a sidewall of a vessel 1400. For example, the thermal harvesting feedback device 1410 may be located inside a handle of a vessel 1400 (e.g., a pot). The thermal harvesting feedback device 1410 may be coupled to a location of the vessel 1400, for example, based on the presence of a thermal gradient at the location of the vessel 1400 (e.g., for a heating/cooling operation of the vessel 1400).

The vessel 1400 may comprise one or more temperature sensors 1420. The thermal harvesting feedback device 1410 may be coupled to the temperature sensor(s) 1420. The thermal harvesting feedback device 1410 may measure the temperature at the temperature sensor(s) 1420. The thermal harvesting feedback device 1410 may measure the temperature at the temperature sensor(s) 1420, for example, based on harvesting energy from a thermal gradient in the vessel 1400. The thermal harvesting feedback device 1410 may send the measured temperature to a user device (e.g., a mobile phone, any device described herein, and/or any other device) and/or a controller (e.g., a base station such as the base station 200, a stove top, an induction cooker, a cooking device, and/or any other controller or device comprising a controller). The thermal harvesting feedback device 1410 may send the measured temperature, for example, via one or more communication protocols (e.g., Bluetooth, NFC, and/or any other communication protocol). The user device and/or the controller may control heating/cooling of the vessel 1400, for example, based on receiving the measured temperature.

FIG. 15 shows an example of an apparatus and/or a system comprising thermal harvesting feedback. A thermal harvesting feedback device may comprise the thermal harvesting feedback device 1410 described with respect to FIG. 14, which may comprise one or more of the operations and/or components described herein with respect to FIG. 15. The thermal harvesting feedback device 1410 may comprise one or more components. The thermal harvesting feedback device 1410 may comprise one or more components and/or operations of any communication module and/or tag described herein. The thermal harvesting feedback device 1410 may comprise, for example, a processing and communication module 1510, a power harvesting module 1520, and/or a temperature sensor 1540 (or any other quantity of temperature sensors). The thermal harvesting feedback device may be coupled to and/or in communications with one or more of a thermoelectric gradient input 1550, a temperature input/output (I/O) 1552, an I/O interface, a programming interface 1556, and/or a transponder 1558. The processing and communication module 1510 may comprise an antenna 1512 (e.g., a Bluetooth antenna) and/or memory 1514. The processing and communication module 1510 may enable the thermal harvesting feedback device 1410 to send and/or receive one or more communications (e.g., via Bluetooth, NFC, RFID, and/or any other communication protocol or device). The memory 1514 may store instructions and/or one or more values measured by the thermal harvesting feedback device 1410 (e.g. temperature, voltage, harvested voltage, input voltage, and/or any other information). The memory 1514 may store an identifier associated with the thermal harvesting feedback device 1410 and/or a vessel (e.g., vessel 1400) to/with which the thermal harvesting feedback device 1410 may be coupled and/or in communication. For example, the memory 1514 may store a product identifier (e.g., serial number, product type/model) associated with the vessel 1400. The memory 1514 may store one or more heating profiles for one or more heating operations, such as described herein. The memory 1514 may store one or more voltages and/or any other indications, for example, based on one or more operations/measurements of the power harvesting module 1520 and/or based on one or more operations/measurements of the temperature sensor 1540.

The power harvesting module 1520 may harvest power. The power harvesting module 1520 may harvest power, for example, to power the processing and communication module 1510. The power harvesting module 1520 may comprise one or more operations of the harvesting module 116 described with respect to FIG. 1. The power harvesting module 1520 may harvest power, for example, from a thermoelectric gradient input 1550 (e.g., a thermocouple, one or more connected thermocouples (e.g., of different materials welded/joined together), etc.). The thermoelectric gradient input 1550 may generate a thermoelectric gradient based on receiving energy in the form of heat (e.g., from an inductive heating source) relative to a heat differential (e.g., from a non-heated area). For example, the thermoelectric gradient input 1550 may generate power using a Peltier effect. The power harvesting module 1520 may require a sufficient thermal gradient at the thermoelectric gradient input 1550 to power the processing and communication module 1510. The power harvesting module 1520 may not harvest the power required to power the processing and communication module 1510, for example, if the thermal gradient at the thermoelectric gradient input 1550 is insufficient (e.g., too small, below the required voltage threshold, etc.). The power harvesting module 1520 may harvest the power required to power the processing and communication module 1510, for example, if the thermal gradient at the thermoelectric gradient input 1550 is sufficient (e.g., at and/or exceeding the required voltage threshold). The power harvesting module 1520 may output a static voltage (e.g., 3.3V, 5V, or any other voltage) to the processing and communication module 1510, for example, if the thermal gradient at the thermoelectric gradient input 1550 is sufficient (e.g., at and/or exceeding the required voltage threshold). The power harvesting module 1520 may store harvested power in a storage device (e.g., a battery, a capacitor, and/or any other electrical storage device). The storage device may be located in a handle of the vessel 1400 and/or any other location that may not be exposed to high temperatures. The storage device may be replaced (e.g., a battery may be replaced), for example, by providing a removable enclosure/cover over the storage device (e.g., removable handle/grip of the vessel 1400, a screw and/or a clip cover, etc.). The storage device may be recharged (e.g., a rechargeable battery), for example, by providing a cord and/or an adapter, for receiving an external power supply and/or charging supply, that may be electrically coupled to the storage device. Additionally or alternatively, the storage device may not require replacement and/or recharging for the expected useful life of the vessel 1400.

The thermal harvesting feedback device 1410 may comprise one or more temperature sensors (e.g., temperature sensor 1540). The one or more temperature sensors (e.g., temperature sensor 1540) may located internal and/or external to the thermal harvesting feedback device 1410. The processing and communication module 1510 may measure the temperature at the temperature sensor(s). The processing and communication module 1510 may be coupled to one or more temperature I/Os (e.g., a temperature I/O 1552). The temperature I/O 1552 may enable the processing and communication module 1510 to measure and/or electrically connect with one or more temperature sensors that may be external to the thermal harvesting feedback device 1410. For example, the thermal harvesting feedback device 1410 may electrically connect to and/or measure the temperature at the temperature sensor 1440, as described herein with respect to FIG. 14, via the temperature I/O 1552.

The thermal harvesting feedback device 1410 may comprise an I/O interface 1554 and/or a programming interface 1556. The I/O interface 1554 may enable the thermal harvesting feedback device 1410 to electrically connect, interface, and/or communicate with one or more I/O devices (e.g., user device, control screen, appliance, mobile phone, and/or any other device). The I/O interface 1514 may enable receiving commands from, and/or sending output information to, the one or more I/O devices, for example, for control and/or operation of the thermal harvesting feedback device 1410. The I/O interface 1554 may comprise one or more indications, such as an LED indication (e.g., indicating active status, inactive status, power on, power off, idle, receiving information, sending information, and/or any other information) and/or a display (e.g., LCD, LED, OLED, etc.). The programing interface 1556 may enable the thermal harvesting feedback device 1410 to receive information from (and/or send information to) an external source for purposes of programming one or more operations of the thermal harvesting feedback device 1410. For example, the thermal harvesting feedback device 1410 may receive instructions via the programming interface 1556 and/or may store instructions in the memory 1514 for operation of the processing and communication module 1510.

The thermal harvesting feedback device 1410 may be coupled to and/or in communication with a transponder 1558. The transponder 1558 may comprise an antenna (e.g., an NFC antenna, RFID antenna, and/or any other antenna). The transponder 1558 may comprise one or more coils. The transponder 1558 may enable the thermal harvesting feedback device 1410 to send and/or receive one or more communications (e.g., via NFC, RFID, and/or any other communication protocol or device). The thermal harvesting feedback device 1410 may send one or more temperature measurements, voltage measurements (e.g., input voltage at the processing and communication module 1510, harvested voltage at the power harvesting module 1520), and/or any other data that may be stored in the memory 1514 (e.g., an identifier for the thermal harvesting feedback device 1410). The thermal harvesting feedback device 1410 may send one or more temperature measurements, voltage measurements, and/or any other data stored in the memory 1514, for example, via the antenna 1512 (e.g., via Bluetooth) and/or via the transponder 1558 (e.g., via NFC). The thermal harvesting feedback device 1410 may receive one or more indications. The thermal harvesting feedback device 1410 may receive one or more indications, for example, via the antenna 1512 and/or via the transponder 1558. The thermal harvesting feedback device 1410 may receive one or more indications, for example, from a user device (e.g., a mobile phone, appliance, and/or any other device) and/or a controller (e.g., a base station such as the base station 200, a stove top, an induction cooker, a cooking device, and/or any appliance or device comprising a controller). The one or more indications may comprise one or more of a command, an error message, a failure, and/or any other indication.

A controller (e.g., a base station 200, a stove top, an induction cooker, a cooking device, and/or any other device comprising a controller) may control heating and/or cooling of the thermal harvesting feedback device 1410 and/or a vessel (e.g., vessel 1400) that may comprise and/or be coupled to the thermal harvesting feedback device 1410. A controller may control heating and/or cooling, for example, based on receiving one or more temperature measurements, voltage measurements (e.g., input voltage at the processing and communication module 1510, harvested voltage at the power harvesting module 1520, etc.), and/or any other data that may be stored in the memory 1514 (e.g., an identifier for the thermal harvesting feedback device 1410), from the thermal harvesting feedback device 1410. A controller may stop heating a vessel 1400 with a connected thermal harvesting feedback device 1410, for example, based on receiving one or more temperature measurements indicating a temperature threshold is exceeded at one or more temperature sensors (e.g., at the temperature sensor 1540).

The vessel 1400 and the thermal harvesting feedback device described with respect to FIG. 14 and/or FIG. 15 may provide various advantages. For example, heating and/or cooking may be performed in a safe environment (e.g., avoiding overheating and/or fires) by monitoring conditions (e.g., temperature, gas, and/or any other condition that may be sensed) and receiving automated control (e.g., via a base station and/or any other device) to adjust heating operations based on the conditions. Food and/or liquid may be heated more quickly to a desired temperature, and/or food may be cooked according to a recipe (e.g., a heating profile) and/or to a preference for a more desirable outcome. Food quality for consumption may be improved and/or may be heated more consistently. Automated and/or partially automated cooking and/or heating may be performed. Indicators may be provided to a user, such as an indication to stop, reduce, and/or increase heating and/or temperature; a warning indication (e.g., burned food content, over-boiling/spillover, fire, etc.). Monitoring and/or communications may be performed without an external power supply and/or without replacement/recharging of an internal power supply.

A smart package may be provided for heating consumable content. The smart package may comprise a container for the consumable content. The consumable content may comprise at least one of a food product, a beverage product, a wax, and/or any substance to be heated. The smart package may comprise a radio frequency identification (RFID) tag that may be affixed to the container. The RFID tag may comprise an antenna, a communication module, and/or an inductive receptor. The communication module may be coupled to the antenna. The communication module may comprise at least one temperature sensor and at least one controller. The at least one temperature sensor may comprise a first temperature sensor and a second temperature sensor in close proximity with the first temperature sensor. The inductive receptor may comprise a void portion in which the RFID tag may be located. The inductive receptor may be configured to transfer heat from an inductive heating element (e.g., in a base station) to the consumable content. The communication module may comprise a memory storing instructions that, when executed by the at least one controller, may cause the smart package to determine whether a measurement by the first temperature sensor differs, by more than a threshold, from a measurement by the second temperature sensor. The instructions, when executed by the at least one controller, may cause the smart package to send, to a base station comprising the inductive heating element, an indication that the measurement by the first temperature sensor differs, by more than the threshold, from the measurement by the second temperature sensor. The communication module may comprise a first voltage reference associated with the first temperature sensor, and a second voltage reference associated with the second temperature sensor. The instructions, when executed by the at least one controller, may cause the smart package to: compare the first voltage reference with the measurement by the first temperature sensor; and compare the second voltage reference with the measurement by the second temperature sensor. The communication module may comprise a balancing module coupled to the antenna and/or configured to tune radio frequency (RF) communications. The communication module may comprise a harvesting module configured to: receive an RF output from the balancing module; and/or generate a voltage output to power the at least one controller. The smart package may comprise at least one indicator. The instructions, when executed by the at least one controller, may cause the at least one indicator to perform at least one of: illuminate the smart package; indicate an operational state of the smart package; and/or indicate a failure. The smart package may comprise an insulating layer. The insulating layer may be coupled to the inductive receptor. The insulating layer may be configured to insulate the inductive receptor from the inductive heating element. The instructions, when executed by the at least one controller, may cause the smart package to: send, to a base station, an identifier stored in the memory and associated with the smart package; receive, from the base station, heat for heating the consumable content; and/or send, to the base station, at least one measurement associated with a temperature of the consumable content.

A smart tag may be provided for heating a substance. The smart tag may comprise: an antenna coupled to a first substrate; a communication module coupled to the antenna; and/or a second substrate coupled to the first substrate. The communication module may comprise at least one temperature sensor and at least one controller. The second substrate may comprise a void portion such that the antenna and the communication module do not contact the second substrate. The second substrate may comprise an inductive receptor configured to transfer heat from an inductive heating element. The at least one temperature sensor may comprise a first temperature sensor and a second temperature sensor in close proximity with the first temperature sensor. The communication module may comprise a memory storing instructions that, when executed by the at least one controller, may cause the smart tag to determine whether a measurement by the first temperature sensor differs, by more than a threshold, from a measurement by the second temperature sensor. The instructions, when executed by the at least one controller, may cause the smart tag to: send, to a base station comprising the inductive heating element, an indication that the measurement by the first temperature sensor differs, by more than the threshold, from the measurement by the second temperature sensor. The communication module may comprise a first voltage reference associated with the first temperature sensor, and a second voltage reference associated with the second temperature sensor. The instructions, when executed by the at least one controller, may cause the smart tag to: compare the first voltage reference with the measurement by the first temperature sensor; and compare the second voltage reference with the measurement by the second temperature sensor. The communication module may comprise a balancing module coupled to the antenna and/or configured to tune radio frequency (RF) communications. The communication module may comprise a harvesting module configured to: receive an RF output from the balancing module; and/or generate a voltage output to power the at least one controller. The smart tag may comprise at least one indicator. The instructions, when executed by the at least one controller, may cause the at least one indicator to perform at least one of: illuminate the smart tag; indicate an operational state of the smart tag; and/or indicate a failure. The smart tag may comprise an insulating layer. The insulating layer may be coupled to the inductive receptor. The insulating layer may be configured to insulate the inductive receptor from the inductive heating element. The instructions, when executed by the at least one controller, may cause the smart tag to: send, to a base station, an identifier stored in the memory and associated with the smart tag; receive heat from the base station; and/or send, to the base station, at least one measurement associated with a temperature. The smart tag may comprise a product packaging. The product packaging may be coupled to the first substrate on a first surface of the first substrate. The antenna may be coupled to the first substrate on a second surface of the first substrate such that the first substrate is in between the antenna and the product packaging.

A method may be performed that comprises coupling an antenna to a first substrate. The method may comprise coupling a communication module to the antenna. The communication module may comprise at least one temperature sensor and at least one controller. The method may comprise coupling a second substrate to the first substrate. The second substrate may comprise a void portion such that the antenna and the communication module do not contact the second substrate. The second substrate may comprise an inductive receptor. The inductive receptor may be configured to transfer heat from an inductive heating element. The method may comprise coupling a third substrate to the second substrate. The third substrate may comprise an insulating layer configured to insulate the inductive receptor from the inductive heating element. The method may comprise coupling a communication tag to a product packaging material, The communication tag may comprise: the antenna; the communication module; and/or the inductive receptor

Any step(s)/operation described herein as being performed by a base station (e.g., the base station 200) may additionally or alternatively be performed by a smart package (e.g., the smart package 100), a smart accessory (e.g., the smart accessory 600), a smart apparatus (e.g., the smart apparatus 700), and/or any other device. Any step(s)/operation described herein as being performed by a smart package (e.g., the smart package 100), a smart accessory (e.g., the smart accessory 600), and/or a smart apparatus (e.g., the smart apparatus 700) may be performed by a base station (e.g., the base station 200) and/or any other device. Any step(s)/operation described herein may be performed in the order described and/or may additionally or alternatively be performed in any other order. One or more of the operations described herein may be conditional. For example, one or more operations may be performed if certain criteria are met, such as in a smart package (e.g., the smart package 100), a base station (e.g., the base station 200), a smart accessory (e.g., the smart accessory 600), a smart apparatus (e.g., the smart apparatus 700), a thermal harvesting feedback device (e.g., the thermal harvesting feedback device 1410), a vessel (e.g., the vessel 1400), any other device, and/or any combination thereof, and/or the like. It may be possible to implement any portion of the examples described herein in any order and based on any condition. One or more elements in examples described herein may be implemented as modules. A module may be an element that may perform a defined function and/or that may have a defined interface to other elements. The modules may be implemented in hardware, software in combination with hardware, firmware, or a combination thereof, all of which may be operationally/functionally equivalent. The operation/functionality of any system, apparatus, and/or method described herein may be included within any computer-readable medium (e.g., non-transitory computer-readable medium). A system, apparatus, method, and/or computer-readable medium may comprise any combination of system, apparatus, method and/or computer-readable medium described herein. For example, a system may comprise one or more of: a smart package (e.g., the smart package 100), a smart accessory (e.g., the smart accessory 600), a smart apparatus (e.g., the smart apparatus 700), a container (e.g., the container 650), a concentrator (e.g., the concentrator 730), a base station (e.g., the base station 200), a thermal harvesting feedback apparatus (e.g., the thermal harvesting feedback apparatus 1410), a vessel (e.g., the vessel 1400), and/or any other device. Although examples are described herein, features and/or steps of these examples may be combined, divided, omitted, rearranged, and/or revised in any manner. Various modifications and/or improvements readily made by those skilled in the art and are intended to be within the scope of the descriptions herein which are provided as not limiting examples.

1. A smart package for heating consumable content, wherein the smart package comprises:
a container for a consumable content;
a radio frequency identification (RFID) tag affixed to the container, wherein the RFID tag comprises:
an antenna; and
a communication module coupled to the antenna, wherein the communication module comprises at least one temperature sensor and at least one controller; and
a substrate including one or more inductive receptors, the substrate comprising a void portion in which the RFID tag is located, wherein the one or more inductive receptors are configured to transfer heat from an inductive heating element to the consumable content;
wherein the at least one temperature sensor and the substrate are each engaged with a surface of the container, and wherein the at least one temperature sensor is isolated from and not in direct contact with the substrate, whereby the at least one temperature sensor provides a temperature reading associated with a consumable content without interference from the one or more inductive receptors.

2. The smart package of claim 1, wherein the at least one temperature sensor comprises a first temperature sensor and a second temperature sensor in close proximity with the first temperature sensor, and wherein the communication module further comprises a memory storing instructions that, when executed by the at least one controller, cause the smart package to determine whether a measurement by the first temperature sensor differs, by more than a threshold, from a measurement by the second temperature sensor.

3. The smart package of claim 2, wherein the instructions, when executed by the at least one controller, further cause the smart package to:
send, to a base station comprising the inductive heating element, an indication that the measurement by the first temperature sensor differs, by more than the threshold, from the measurement by the second temperature sensor.

4. The smart package of claim 2, wherein the communication module further comprises:
a first voltage reference associated with the first temperature sensor, and
a second voltage reference associated with the second temperature sensor; and
wherein the instructions, when executed by the at least one controller, further cause the smart package to:
compare the first voltage reference with the measurement by the first temperature sensor; and
compare the second voltage reference with the measurement by the second temperature sensor.

5. The smart package of claim 1, wherein the communication module further comprises:
a balancing module coupled to the antenna and configured to tune radio frequency (RF) communications; and
a harvesting module configured to:
receive an RF output from the balancing module; and
generate a voltage output to power the at least one controller.

6. The smart package of claim 1, further comprising:
at least one indicator; and
wherein the communication module further comprises a memory storing instructions that, when executed by the at least one controller, cause the at least one indicator to perform at least one of:
illuminate the smart package;
indicate an operational state of the smart package; or
indicate a failure.

7. The smart package of claim 1, further comprising an insulating layer, wherein the insulating layer is coupled to the inductive receptor and is configured to insulate the inductive receptor from the inductive heating element.

8. The smart package of claim 1, wherein the communication module further comprises a memory storing instructions that, when executed by the at least one controller, cause the smart package to:
send, to a base station, an identifier stored in the memory and associated with the smart package;
receive, from the base station, heat for heating the consumable content; and
send, to the base station, at least one measurement associated with a temperature of the consumable content.

9. A smart tag for heating a substance, wherein the smart tag comprises:
an antenna coupled to a first substrate;
a communication module coupled to the antenna, wherein the communication module comprises at least one temperature sensor and at least one controller; and
a second substrate coupled to the first substrate, wherein the second substrate comprises:
a void portion such that the antenna and the communication module do not contact the second substrate; and
an inductive receptor, wherein the inductive receptor is configured to transfer heat from an inductive heating element; and
wherein the at least one temperature sensor and the second substrate are configured for engagement with a surface of a container, and wherein the at least one temperature sensor is disposed within the void portion of the second substrate and isolated from and not in direct contact with the second substrate, whereby the at least one temperature sensor provides a temperature reading associated with a consumable content without interference from the inductive receptor.

10. The smart tag of claim 9, wherein the at least one temperature sensor comprises a first temperature sensor and a second temperature sensor, in close proximity with the first temperature sensor, and wherein the communication module further comprises a memory storing instructions that, when executed by the at least one controller, cause the smart tag to determine whether a measurement by the first temperature sensor differs, by more than a threshold, from a measurement by the second temperature sensor.

11. The smart tag of claim 10, wherein the instructions, when executed by the at least one controller, further cause the smart tag to:
send, to a base station comprising the inductive heating element, an indication that the measurement by the first temperature sensor differs, by more than the threshold, from the measurement by the second temperature sensor.

12. The smart tag of claim 10, wherein the communication module further comprises:
a first voltage reference associated with the first temperature sensor, and
a second voltage reference associated with the second temperature sensor; and
wherein the instructions, when executed by the at least one controller, further cause the smart tag to:
compare the first voltage reference with the measurement by the first temperature sensor; and
compare the second voltage reference with the measurement by the second temperature sensor.

13. The smart tag of claim 9, wherein the communication module further comprises:
a balancing module coupled to the antenna and configured to tune radio frequency (RF) communications; and
a harvesting module configured to:
receive an RF output from the balancing module; and
generate a voltage output to power the at least one controller.

14. The smart tag of claim 9, further comprising:
at least one indicator; and
wherein the communication module further comprises a memory storing instructions that, when executed by the at least one controller, cause the at least one indicator to perform at least one of:
illuminate the smart tag;
indicate an operational state of the smart tag; or
indicate a failure.

15. The smart tag of claim 9, further comprising an insulating layer, wherein the insulating layer is coupled to the inductive receptor and is configured to insulate the inductive receptor from the inductive heating element.

16. The smart tag of claim 9, wherein the communication module further comprises a memory storing instructions that, when executed by the at least one controller, cause the smart tag to:
send, to a base station, an identifier stored in the memory and associated with the smart tag;
receive heat from the base station; and
send, to the base station, at least one measurement associated with a temperature.

17. The smart tag of claim 9, further comprising a product packaging, wherein the product packaging is coupled to the first substrate on a first surface of the first substrate, and wherein the antenna is coupled to the first substrate on a second surface of the first substrate such that the first substrate is in between the antenna and the product packaging.

18. A method comprising:
coupling an antenna to a first substrate;
coupling a communication module to the antenna, wherein the communication module comprises at least one temperature sensor and at least one controller;
coupling a second substrate to the first substrate, wherein the second substrate comprises:
a void portion such that the antenna and the communication module do not contact the second substrate; and
an inductive receptor, wherein the inductive receptor is configured to transfer heat from an inductive heating element;
wherein coupling the second substrate includes:
configuring the at least one temperature sensor and the second substrate for engagement with a surface of a container; and
disposing the at least one temperature sensor within the void portion of the second substrate such that it is isolated from and not in direct contact with the second substrate;
providing, with the at least one temperature sensor, a temperature reading associated with a consumable content without interference from the inductive receptor.

19. The method of claim 18, further comprising:
coupling a third substrate to the second substrate, wherein the third substrate comprises an insulating layer configured to insulate the inductive receptor from the inductive heating element.

20. The method of claim 18, further comprising:
coupling a communication tag to a product packaging material, wherein the communication tag comprises:
the antenna;
the communication module; and
the inductive receptor.
